(19) United States
(12) Patent Application Publication
(10) Pub. No.: US 2009/0240885 A1
(43) Pub. Date: Sep. 24, 2009

(54) MEMORY CARD COMPLYING WITH A PLURALITY OF STANDARDS

(76) Inventor: Masaharu Adachi, Osaka (JP)

Correspondence Address: DICKSTEIN SHAPIRO LLP, 1825 EYE STREET NW, Washington, DC, 20006-5403, US

(21) Appl. No.: 12/092,572

(22) PCT Filed: Aug. 31, 2007
(86) PCT No.: PCT/JP2007/067464

§ 371 Date: May 2, 2008

(51) Int. Cl. G06F 12/00

(52) U.S. Cl. 711/115; 711/E12.001; 711/E12.008

(57) ABSTRACT

A memory card includes a control device, a nonvolatile memory, and a program-storage memory, wherein the program-storage memory is arranged to store a plurality of control programs corresponding to respective standards for controlling data access between the nonvolatile memory and an external device.

### TECHNICAL FIELD

The present invention relates to a memory card complying with a plurality of standards, and also relates to a method of switching the standards.

### BACKGROUND ART

Nonvolatile memory cards such as the SD card (registered trademark) and the MMC (multi-media card: registered trademark) are utilized as a means for exchanging information between portable digital equipment such as portable phones and digital cameras and digital equipment such as personal computers and printers.

The SD card and the MMC, which are cited above as examples of nonvolatile memory cards, have similar electrical characteristics and card shape. These two cards, however, are not perfectly compatible with each other in terms of control method and communication method, and one of these nonvolatile memory cards may not be used in a card receptacle that is provided for the other nonvolatile memory card.

Moreover, a conventional nonvolatile memory card is only provided with a single nonvolatile memory card controller, which is not perfectly compatible with a nonvolatile memory card controller complying with a different standard. In the first place, a conventional nonvolatile memory card is not equipped with a switch for switching nonvolatile memory card controllers or a switch for switching internal programs.

In the following, the SD card and the MMC will be used as examples for analysis. The SD card and the MMC have high compatibility in terms of their shape and electrical specifications, so that an identical controller may be used in these two cards. Because of this, the rewriting of control programs in a memory card can make the specification of this memory card match the specification of the other memory card despite the fact that the control instructions and protocols differ between these two memory cards. The rewriting of control programs in a memory card is unfortunately an extremely difficult task.

Some of the host controllers (i.e., controllers provided in the host computers) support only either one of the SD card and the MMC. In this case, only either one of the two memory cards can operate with a given host computer.

There are some host controllers that support both the SD card and the MMC. When a memory card different from the memory card that the host controller is designed to support is connected, e.g., when a high-speed MMC is connected to an SD card host controller that can only support a normal-speed MMC, this controller can only perform a normal-speed-MMC-compatible data transfer at transfer rate lower than that of the SD card. Even in this case, the data transfer can be performed at higher transfer rate if the MMC can be made to operate as an SD card.

The problems as described above may also arise between the SD card and the SDHC memory card (registered trademark) that is a generic-standard card encompassing the SD card, and may also arise with respect to their host controllers. The size of the nonvolatile memory of the SDHC memory card is greater than the maximum size of the nonvolatile memory of the SD card. In this case, a host controller designed to support the SD card cannot support the SDHC memory card despite the fact that shape and electrical characteristics are the same between these two cards.

Even if a controller compatible with the SD card is implemented in an SDHC memory card, the host controller designed to support the SD card cannot recognize the data area of the SDHC memory card exceeding 4 GB because the SD card does not support a data area exceeding 2 GB.

Patent Document 1 discloses a technology for use in a host controller to detect and determine a memory card, but is not directed to the switching of controllers inside a memory card. Patent Document 2 discloses the integration of the SD, the MMC, and the SIM. Patent Document 3 discloses a technology for use in an adaptor that provides shape conversion to convert a mini-type MMC into an SD card.

There is a need for a nonvolatile memory card that is operable with a host controller of a host computer and card receptacle of any standard when there are plural types of nonvolatile memory cards that have similar electrical characteristics and shapes but comply with different standards.

[Patent Document 1]

Japanese Patent No. 3655597

[Patent Document 2]

International Publication WO01/084490

[Patent Document 3]

Japanese Utility Model Registration No. 3114194

### DISCLOSURE OF INVENTION

At least one embodiment of the present invention may achieve one or more of the objects as set forth above.

A memory card according to the present invention includes a control device, a nonvolatile memory, and a program-storage memory, wherein the program-storage memory is arranged to store a plurality of control programs corresponding to respective standards for controlling data access between the nonvolatile memory and an external device.

A memory card according to the present invention includes a plurality of control devices, a nonvolatile memory, and a write-protection switch, wherein the control devices are configured to control data access between the nonvolatile memory and an external device according to respective memory card standards, and the write-protection switch is configured as a changeover switch to select one of the control devices.

A memory card according to the present invention includes a control device, a nonvolatile memory, a program-storage memory, and a write-protection switch, wherein the program-storage memory is arranged to store a plurality of control programs corresponding to respective standards for controlling data access between the nonvolatile memory and an external device, and the write-protection switch is configured as a changeover switch to select one of the control programs.

A memory card according to the present invention includes a control device, a nonvolatile memory, a program-storage memory, and a switch, wherein the program-storage memory is arranged to store a plurality of control programs corresponding to respective standards for controlling data access between the nonvolatile memory and an external device, and the control device is configured to monitor a state of a signal supplied from the switch to execute one of the control programs for a selected memory card in response to the state of the signal.

A memory card according to the present invention includes a control device, a nonvolatile memory, a program-storage memory, a switch; and a switch, wherein the program-storage memory is arranged to store a plurality of control programs corresponding to respective standards for controlling data access between the nonvolatile memory and an external device, and the control device is configured to respond to the reset signal acquisition circuit acquiring a reset signal by receiving a state of a signal supplied from the switch to execute one of the control programs for a selected memory card in response to the state of the signal.

A memory card according to the present invention includes a control device, a nonvolatile memory, a program-storage memory, and a switch, wherein the program-storage memory is arranged to store a plurality of control programs corresponding to respective standards for controlling data access between the nonvolatile memory and an external device, and the control device is configured to respond to a predetermined command supplied from an external device by receiving a state of a signal supplied from the switch to execute one of the control programs for a selected memory card in response to the state of the signal.

A memory card according to the present invention includes a control device, a nonvolatile memory, and a program-storage memory, wherein the program-storage memory is arranged to store a plurality of control programs corresponding to respective standards for controlling data access between the nonvolatile memory and an external device, and the control device is configured to monitor a command supplied from or protocol of access made by an external device, to select one of the control programs in response to the monitored command or protocol, and to execute the selected one of the control programs for a selected memory card.

A memory card according to the present invention includes a control device, a nonvolatile memory, and a program-storage memory, wherein the program-storage memory is arranged to store a command check program for checking a command supplied from an external device, a memory-card-shared-portion control program, and a plurality of memory-card-dedicated control programs corresponding to respective standards, wherein the memory-card-shared-portion control program is configured to control data access between the nonvolatile memory and an external device by performing control that is common to a plurality of memory cards corresponding to the respective standards, wherein the memory-card-dedicated control programs are configured to control the data access between the nonvolatile memory and the external device by performing control specific to the respective memory cards, and wherein the control device is configured to use the command check program to check a command supplied from an external device, and to select and execute at least one of the memory-card-shared-portion control program and the memory-card-dedicated control programs in response to the checked command.

A memory card according to the present invention includes a data-storage nonvolatile memory corresponding to a first memory card standard and a control device configured to support the first memory card standard providing a first data volume and a second memory card standard providing a second data volume smaller than the first data volume, wherein a portion of the data-storage nonvolatile memory is used as a data-storage area of a memory card of the second memory card standard.

A memory card according to the present invention includes a data-storage nonvolatile memory corresponding to a first memory card standard and a control device configured to support the first memory card standard providing a first data volume and a second memory card standard providing a second data volume smaller than the first data volume, wherein a data area portion of the data-storage nonvolatile memory is used as a data-storage area of a memory card of the second memory card standard.

A memory card according to the present invention includes a data-storage nonvolatile memory corresponding to a first memory card standard and a control device configured to support the first memory card standard providing a first data volume and a second memory card standard providing a second data volume smaller than the first data volume, wherein the data-storage nonvolatile memory is divided into a plurality of areas, one of which is used as a data-storage area of a memory card of the second memory card standard when the control device operates in a mode compatible with the second memory card standard.

A memory card according to the present invention includes a data-storage nonvolatile memory corresponding to a first memory card standard and a control device configured to support the first memory card standard providing a first data volume and a second memory card standard providing a second data volume smaller than the first data volume, wherein a directory in a memory area of the data-storage nonvolatile memory is allocated as a data-storage area that is used when the control device operates in a mode compatible with the second memory card standard.

A memory card according to the present invention includes a data-storage nonvolatile memory corresponding to a first memory card standard and a control device configured to support the first memory card standard providing a first data volume and a second memory card standard providing a second data volume smaller than the first data volume, wherein a file in a memory area of the data-storage nonvolatile memory is allocated as a data-storage area that is used when the control device operates in a mode compatible with the second memory card standard.

A memory card according to the present invention includes a data-storage nonvolatile memory corresponding to a first memory card standard and a control device configured to support the first memory card standard providing a first data volume and a second memory card standard providing a second data volume smaller than the first data volume, wherein a compressed file in a memory area of the data-storage nonvolatile memory is allocated as a data-storage area that is used when the control device operates in a mode compatible with the second memory card standard.

A memory card according to the present invention includes a nonvolatile memory having a first data-storage area corresponding to a first memory card standard and a second data-storage area corresponding to a second memory card standard, and a control device configured to support the first memory card standard providing a first data volume and the second memory card standard providing a second data volume smaller than the first data volume, wherein the second data-storage area is accessible by using a command or protocol supported by neither the first memory card standard nor the second memory card standard.

According to at least one embodiment of the present invention, a single memory card can comply with a plurality of standards that are compatible in terms of electrical characteristics and card receptacles. Further, a write-protection switch, changeover switch, reset signal, or command from a host controller may be utilized to select one of a plurality of control programs corresponding to respective standards, to select one of a plurality of control devices corresponding to respective standards, or to select one of a plurality of memory cards. Moreover, a control process to be performed may be activated in response to a command from a host controller.

### BRIEF DESCRIPTION OF DRAWINGS

FIG. 1 is a block diagram showing an interior configuration of a nonvolatile memory card according to the first embodiment of the present invention.

FIGS. 2A and 2B are block diagrams showing an interior configuration of a nonvolatile memory card according to the second embodiment of the present invention.

FIGS. 3A and 3B are block diagrams showing an interior configuration of a nonvolatile memory card according to the third embodiment of the present invention.

FIG. 4A is a block diagram showing an interior configuration of a nonvolatile memory card according to the fourth embodiment of the present invention.

FIG. 4B is a flowchart showing the procedure of the interruption handler program that selects a control program for a memory card upon the setting of the switch 17.

FIG. 5A is a block diagram showing an interior configuration of a nonvolatile memory card according to the fifth embodiment of the present invention.

FIG. 5B is a flowchart showing the procedure of the initialization program that selects a control program for a memory card upon reset.

FIG. 6A is a block diagram showing an interior configuration of a nonvolatile memory card according to the sixth embodiment of the present invention.

FIG. 6B is a flowchart showing the operation of the control device that selects a control program for a memory card upon the receipt of a reset command sent from the host controller.

FIG. 7A is a block diagram showing an interior configuration of a nonvolatile memory card according to the seventh embodiment of the present invention.

FIG. 7B is a flowchart showing the operation of the control device that selects a control program for a memory card by analyzing the protocol of access by the host controller.

FIG. 8 is a block diagram showing an interior configuration of a nonvolatile memory card according to the eighth embodiment of the present invention.

FIG. 9 is a flowchart showing the operation of the control device 4 of the memory card.

FIG. 10 is a block diagram showing an interior configuration of a nonvolatile memory card according to the ninth embodiment of the present invention.

FIG. 11 is a block diagram showing an interior configuration of a nonvolatile memory card according to the tenth embodiment of the present invention.

FIG. 12 is a block diagram showing an interior configuration of a nonvolatile memory card according to the eleventh embodiment of the present invention.

FIG. 13 is a block diagram showing an interior configuration of a nonvolatile memory card according to the twelfth embodiment of the present invention.

FIG. 14 is a block diagram showing an interior configuration of a nonvolatile memory card according to the thirteenth embodiment of the present invention.

FIG. 15 is a block diagram showing an interior configuration of a nonvolatile memory card according to the fourteenth embodiment of the present invention.

FIG. 16 is a block diagram showing an interior configuration of a nonvolatile memory card according to the fifteenth embodiment of the present invention.

FIG. 17 is a drawing showing a memory card which is provided with the function of a control device for the SD card and the function of a control device for the SDHC memory card.

FIG. 18 is a drawing showing a memory card which is provided with the function of a control device for the SD card and the function of a control device for the SDHC memory card.

FIG. 19 is a drawing showing a memory card which is provided with the function of a control device for the SD card and the function of a control device for the SDHC memory card.

FIG. 20 is a drawing showing a memory card which is provided with the function of a control device for the SD card and the function of a control device for the SDHC memory card.

FIG. 21 is a drawing showing a memory card which is provided with the function of a control device for the SD card and the function of a control device for the SDHC memory card.

### BEST MODE FOR CARRYING OUT THE INVENTION

In the following, preferred embodiments of the present invention will be described with reference to the accompanying drawings.

According to the present invention, control programs are provided in a memory card for the purpose of complying with a plurality of standards, and an external switch or internal control program is utilized to switch the control programs or control devices inside the memory card, thereby selecting a memory card standard suitable for a host controller.

In the present invention, the plurality of standards described above are supposed to be those which have similar shapes and similar electrical characteristics. Examples which will be described below (first through eighth embodiments) are directed to the SD card and the MMC card and directed to the SD card and the SDHC memory card. The present invention is not limited to these particular cards.

### First Embodiment

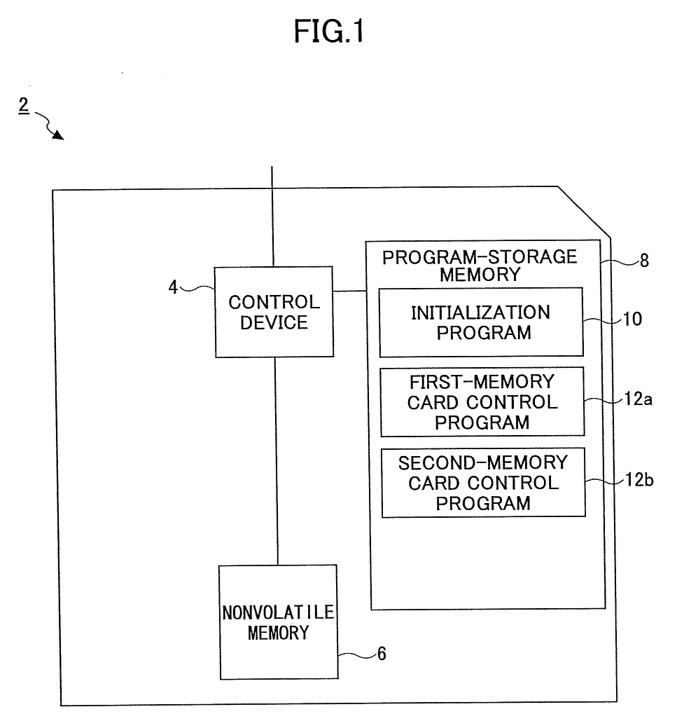

FIG. 1 is a block diagram showing an interior configuration of a nonvolatile memory card according to the first embodiment of the present invention. A nonvolatile memory card 2 according to the first embodiment includes a control device 4, a nonvolatile memory 6, and a program-storage memory 8.

The nonvolatile memory card 2 serves to perform data transfer between the nonvolatile memory 6 and a host controller (not shown) via the control device 4. A control program 12a for controlling a first memory card, a control program 12b for controlling a second memory card, and an initialization program 10 are provided as control programs.

In the nonvolatile memory card 2 according to the first embodiment, the control program 12a or 12b for the first memory card or second memory card may be performed after the execution of the initialization program 10. For example, a control program for the SD card or control program for the MMC is performed so that the nonvolatile memory card 2 operates as an SD card or an MMC. A method for making a choice and mechanism for operation will be described with reference to a third embodiment and onwards.

Another example is that the control program 12a for the first memory card is a control program for the SD card, and the control program 12b for the second memory card is a control program for the SDHC memory card.

### Second Embodiment

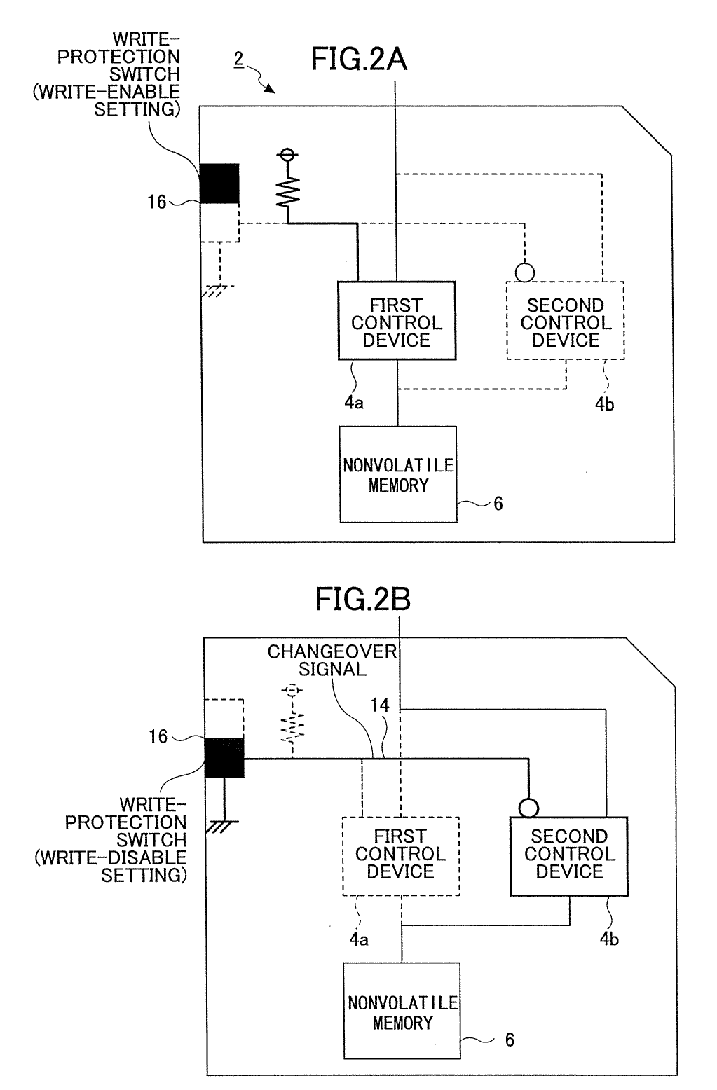

FIGS. 2A and 2B are block diagrams showing an interior configuration of a nonvolatile memory card according to the second embodiment of the present invention. A nonvolatile memory card 2 according to the second embodiment includes a first control device 4a, a second control device 4b, a nonvolatile memory 6, and a write-protection switch 16.

The nonvolatile memory card 2 serves to perform data transfer between the nonvolatile memory 6 and a host controller (not shown) via the control device (i.e., the first control device 4a or the second control device 4b). The control device 4 is for controlling a first memory card, and the control device 4b is for controlling a second memory card. The number of control devices may be larger.

In the nonvolatile memory card 2 according to the second embodiment, the write-protection switch 16 provides protection against writing to the first memory card, but does not provide protection against writing to the second memory card.

The circuit is configured such that when the write-protection switch 16 is set to a write-enable position as shown in FIG. 2A, the control device 4a is placed in an operating state. In this case, the host controller can exchange data with the nonvolatile memory card 2 according to the method of the first memory card. Since the write-protection switch 16 is set to the write-enable position, data can be written to the memory card serving as the first memory card.

Further, the circuit is configured such that when the write-protection switch 16 is set to a write-disable position as shown in FIG. 2B, the control device 4b is placed in an operating state. In this case, the host controller can exchange data with the nonvolatile memory card 2 according to the method of the second memory card. Since the write-protection switch 16 does not provide write protection for the second memory card despite the fact that the write-protection switch 16 is set to the write-disable position (i.e., the switch setting is disregarded), data can be written to the memory card serving as the second memory card.

In the following, a description will be given of an example of a memory card which is provided with a control device for the SD card and a control device for the MMC. The SD card corresponds to the first memory card described above, and the MMC corresponds to the second memory card described above. When an operation as the SD card is desired, the write-protection switch 16 is set to the write-enable position. In this case, the host controller can exchange data with the nonvolatile memory card 2 according to the method of the SD card. Since the write-protection switch 16 is set to the write-enable position, data can be written to the nonvolatile memory card 2.

When an operation as the MMC is desired, the write-protection switch 16 is set to the write-disable position. In this case, the host controller can exchange data with the nonvolatile memory card 2 according to the method of the MMC. Since the setting of the write-protection switch 16 is disregarded, data can be written to the nonvolatile memory card 2.

Another example is that a memory card is provided with a control device for the SD card and a control device for the SDHC memory card. The SD card corresponds to the first memory card, and the SDHC memory card corresponds to the second memory card.

In the nonvolatile memory card 2 according to the second embodiment, the write-enable/disable switching mechanism by use of the write-protection switch 16 is utilized to switch the control devices for the memory card. This makes it possible to add the switching function without adding another physical switch.

### Third Embodiment

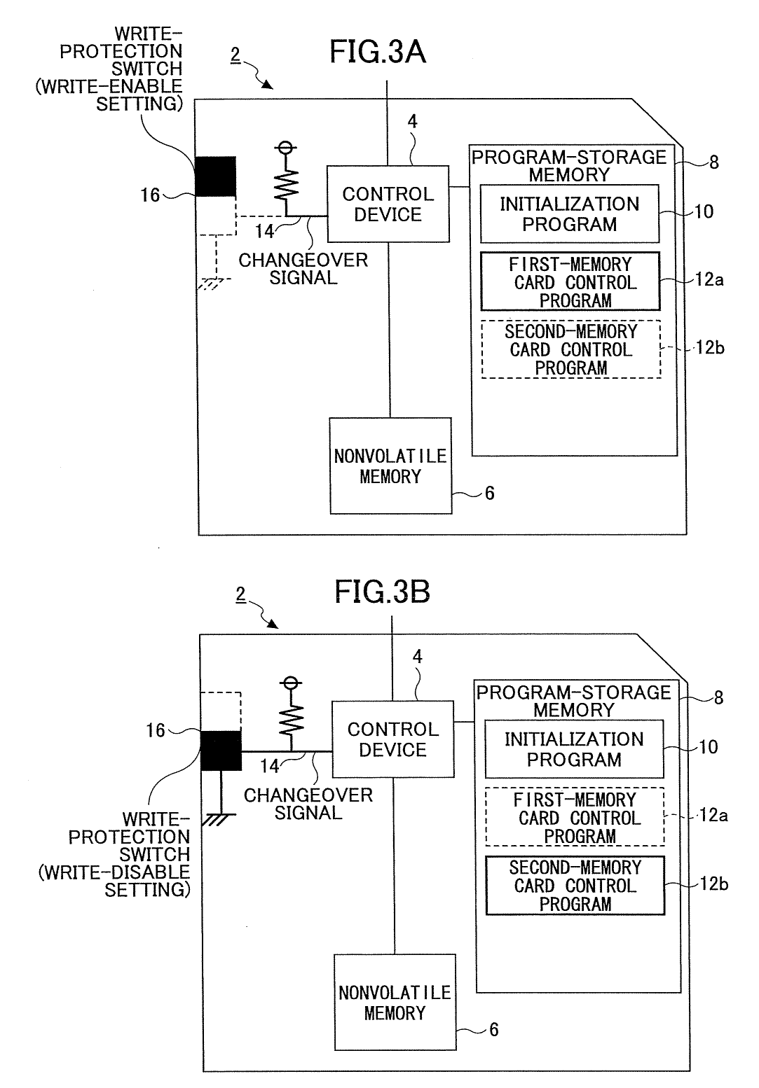

FIGS. 3A and 3B are block diagrams showing an interior configuration of a nonvolatile memory card according to the third embodiment of the present invention. A nonvolatile memory card 2 according to the third embodiment includes a control device 4, a nonvolatile memory 6, a program-storage memory 8, and a write-protection switch 16.

The nonvolatile memory card 2 serves to perform data transfer between the nonvolatile memory 6 and a host controller (not shown) via the control device 4. A control program 12a for controlling a first memory card, a control program 12b for controlling a second memory card, and an initialization program 10 are provided as control programs.

In the nonvolatile memory card 3 according to the second embodiment, the write-protection switch 16 provides protection against writing to the first memory card, but does not provide protection against writing to the second memory card.

Provision is made such that when the write-protection switch 16 is set to a write-enable position as shown in FIG. 3A, the initialization program serves to select the control program 12a for the first memory card. In this case, the host controller can exchange data with the nonvolatile memory card 1 according to the method of the second memory card. Since the write-protection switch 16 is set to the write-enable position, data can be written to the memory card serving as the first memory card.

Further, provision is made such that when the write-protection switch 16 is set to a write-disable position as shown in FIG. 3B, the initialization program serves to select the control program 12b for the second memory card. In this case, the host controller can exchange data with the nonvolatile memory card 2 according to the method of the second memory card. Since the write-protection switch 16 does not provide write protection for the second memory card despite the fact that the write-protection switch 16 is set to the write-disable position (i.e., the switch setting is disregarded), data can be written to the memory card serving as the second memory card.

In the following, a description will be given of an example of a memory card which is provided with a control program for the SD card and a control program for the MMC. The SD card corresponds to the first memory card described above, and the MMC corresponds to the second memory card described above. When an operation as the SD card is desired, the write-protection switch 16 is set to the write-enable position. In this case, the host controller can exchange data with the nonvolatile memory card 2 according to the method of the SD card. Since the write-protection switch 16 is set to the write-enable position, data can be written to the nonvolatile memory card 2.

When an operation as the MMC is desired, the write-protection switch 16 is set to the write-disable position. In this case, the host controller can exchange data with the nonvolatile memory card 2 according to the method of the MMC. Since the setting of the write-protection switch 16 is disregarded, data can be written to the nonvolatile memory card 2.

Another example is that a memory card is provided with a control device for the SD card and a control device for the SDHC memory card. The SD card corresponds to the first memory card, and the SDHC memory card corresponds to the second memory card.

As in the second embodiment, the nonvolatile memory card 2 according to the third embodiment is configured such that the write-enable/disable switching mechanism by use of the write-protection switch 16 is utilized to switch the control devices for the memory card. This makes it possible to add the switching function without adding another physical switch.

In the nonvolatile memory card 2 according to the third embodiment, a single control device is provided. Compared with the memory card of the second embodiment which is provided with a plurality of control devices, thus, the cost can be reduced.

### Fourth Embodiment

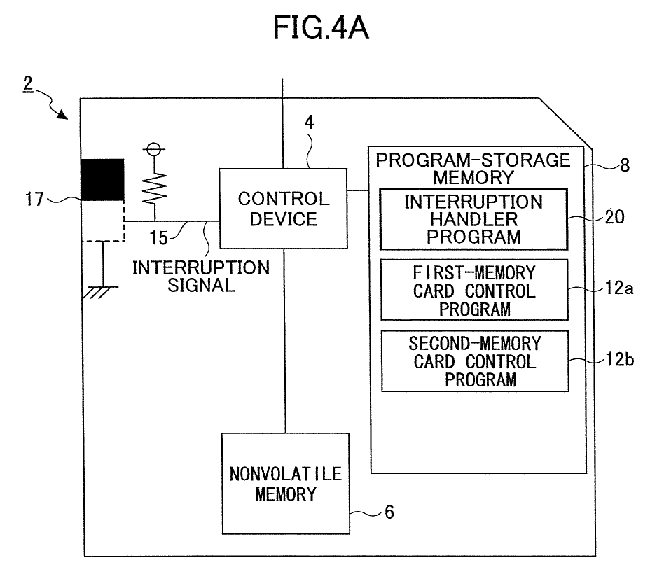

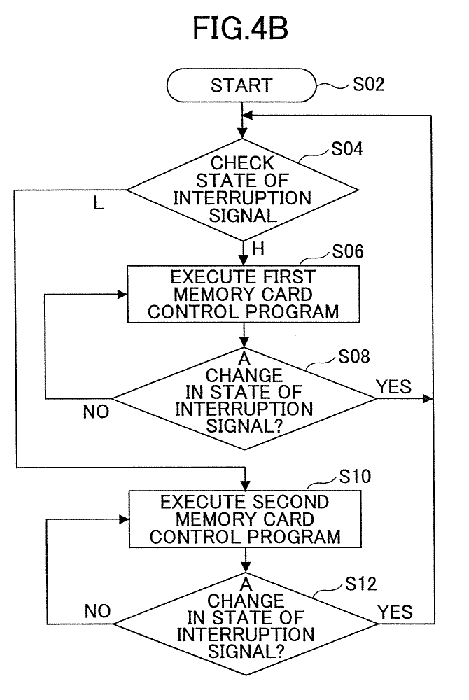

FIG. 4A is a block diagram showing an interior configuration of a nonvolatile memory card according to the fourth embodiment of the present invention. The nonvolatile memory card according to the fourth embodiment is substantially the same as the nonvolatile memory card according to the third embodiment. The same elements as those of such embodiment are referred to by the same numerals, and a description thereof will be omitted.

In the case of the nonvolatile memory card according to the third embodiment described above, the timing of switching control programs is not defined. The nonvolatile memory card 2 according to the fourth embodiment is configured that the time at which a switch 17 is shifted to the other position is used as the timing of switching the control programs. The nonvolatile memory card 2 according to the fourth embodiment includes the switch 17, which generates an interruption signal 15. Alternatively, the write-protection switch 16 may be used as the switch 17.

As shown in FIG. 4A, the switch 17 is set to an open position when the use of the nonvolatile memory card 2 as the first memory card is desired. In this case, an interruption occurs upon the switching, so that an interruption handler program 20 stored in the program-storage memory 8 is executed to select the control program for the first memory card. As a result, the host controller can exchange data with the nonvolatile memory card 2 according to the method of the first memory card.

On the other hand, the switch 17 is set to a closed position when the use of the nonvolatile memory card 2 as the second memory card is desired. In this case, also, an interruption occurs upon the switching, so that the interruption handler program 20 stored in the program-storage memory 8 is executed to select the control program for the second memory card. As a result, the host controller can exchange data with the nonvolatile memory card 2 according to the method of the second memory card.

FIG. 4B is a flowchart showing the procedure of the interruption handler program that selects a control program for a memory card upon the setting of the switch 17. Upon the start of the procedure (e.g., upon switch-on) (S02), the interruption handler program 20 determines the state of the interruption signal 15 transmitted from the switch 17 (S04), and, in response thereto, executes the control program for the first memory card or the control program for the second memory card (S06, S10). In FIG. 4B, “H” with respect to S04 corresponds to the open state of the switch 17, and “L” corresponds to the closed state of the switch 17.

Upon a change in the state of the switch 17 (“YES” at S08, “YES” at S12) even during the execution (S06, S10) of the control program 12a for the first memory card or the control program 12b for the second memory card, the interruption handler program 20 determines the state of the interruption signal 15 (S04), and, in response thereto, executes the control program for the first memory card or the control program for the second memory card (S06, S10).

In the following, a description will be given of an example of a memory card which is provided with a control program for the SD card and a control program for the MMC. The SD card corresponds to the first memory card described above, and the MMC corresponds to the second memory card described above. When an operation as the SD card is desired, the switch 17 is set to the open position. In this case, an interruption occurs upon the switching, so that the interruption handler program 20 selects the control program for the SD card. The host controller can exchange data with the nonvolatile memory card 2 according to the method of the SD card.

When an operation as the MMC is desired, the switch 17 is set to the closed position. In this case, an interruption occurs upon the switching, so that the interruption handler program 20 selects the control program for the MMC. The host controller can exchange data with the nonvolatile memory card 2 according to the method of the MMC.

Another example is that a memory card is provided with a control device for the SD card and a control device for the SDHC memory card. The SD card corresponds to the first memory card, and the SDHC memory card corresponds to the second memory card.

In the nonvolatile memory card 2 according to the fourth embodiment, an interruption process is performed in response to a change in the setting of the switch 17. Accordingly, switching to another memory card type is performed even when the switch 17 is changed inadvertently or by accident, thereby preventing malfunction.

### Fifth Embodiment

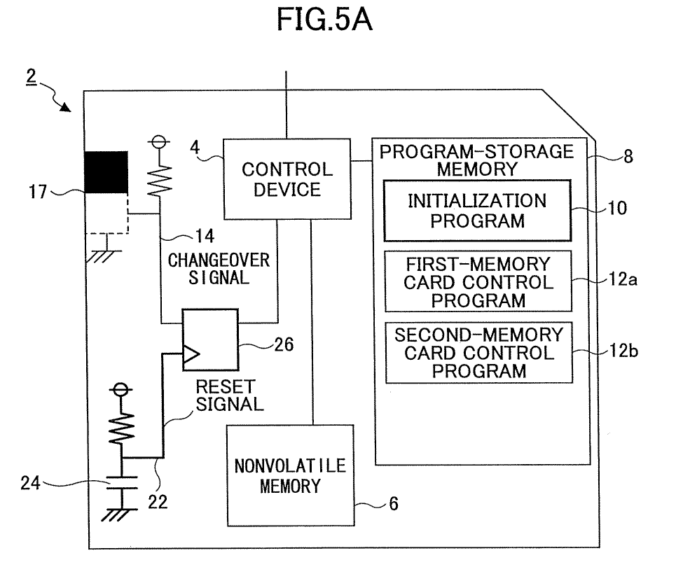

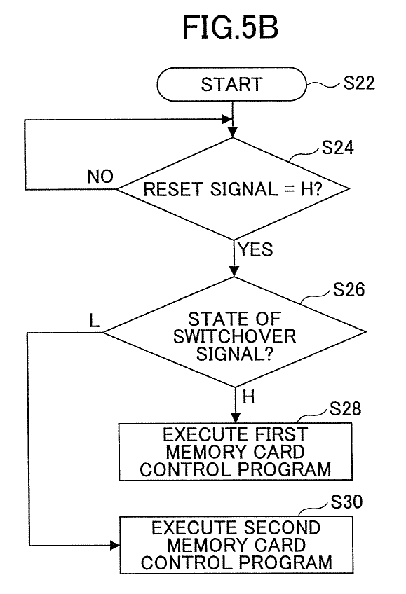

FIG. 5A is a block diagram showing an interior configuration of a nonvolatile memory card according to the fifth embodiment of the present invention. The nonvolatile memory card according to the fifth embodiment is substantially the same as the nonvolatile memory card according to the fourth embodiment. The same elements as those of such embodiment are referred to by the same numerals, and a description thereof will be omitted. In the nonvolatile memory card 2 according to the fifth embodiment, the switch 17 generates a changeover signal 14. Alternatively, the write-protection switch 16 may be used as the switch 17.

In the nonvolatile memory card 2 according to the fifth embodiment, the resetting operation performed upon power-on causes a control program to be set for the memory card. A flip-flop circuit 26 is provided inside or outside the control device 4 of the nonvolatile memory card 2. The flip-flop circuit 26 receives at its data input the changeover signal 14 supplied from the switch 17, and receives a reset signal 22 at its clock input. The output of the flip-flop circuit 26 is used by the control device 4 as a switch signal for switching control programs. The reset signal 22 may also be used to reset the control device 4.

The switch 17 is set to an open position when the use of the nonvolatile memory card 2 as the first memory card is desired. In this case, the initialization program selects the control program for the first memory card upon the “H” state of the reset signal 22 responding to the power-on of the nonvolatile memory card. As a result, the host controller can exchange data with the nonvolatile memory card 1 according to the method of the second memory card.

On the other hand, the switch 17 is set to a closed position when the use of the nonvolatile memory card 2 as the second memory card is desired. In this case, the initialization program selects the control program for the second memory card upon the “H” state of the reset signal 22 responding to the power-on of the nonvolatile memory card. As a result, the host controller can exchange data with the nonvolatile memory card 2 according to the method of the second memory card.

FIG. 5B is a flowchart showing the procedure of the initialization program that selects a control program for a memory card upon reset. The initialization program 10 determines the state of the changeover signal 14 (S26) at the time the reset signal 22 becomes “H” (“YES” at S24), and, in response thereto, executes the control program for the first memory card or the control program for the second memory card (S28, S30). Accordingly, the control program to be executed is selected in response to the state of the switch 17 only upon the occurrence of reset operation.

In the following, a description will be given of an example of a memory card which is provided with a control program for the SD card and a control program for the MMC. The SD card corresponds to the first memory card described above, and the MMC corresponds to the second memory card described above. When an operation as the SD card is desired, the switch 17 is set to the open position. In this case, the initialization program 10 selects the control program for the SD card upon the “H” state of the reset signal 22 responding to the power-on of the memory card. The host controller can exchange data with the nonvolatile memory card 2 according to the method of the SD card.

When an operation as the MMC is desired, the switch 17 is set to the closed position. In this case, the initialization program 10 selects the control program for the MMC upon the “H” state of the reset signal 22 responding to the power-on of the memory card. The host controller can exchange data with the nonvolatile memory card 2 according to the method of the MMC.

Another example is that a memory card is provided with a control device for the SD card and a control device for the SDHC memory card. The SD card corresponds to the first memory card, and the SDHC memory card corresponds to the second memory card.

In the nonvolatile memory card 2 according to the fifth embodiment, the reset signal generated upon the power-on of the memory card is utilized to select a control program. Accordingly, no change in the setting of the control program occurs unless a reset signal is generated. The selected standard of the memory card is not changed even when the switch is shifted to the other position for some reason.

### Sixth Embodiment

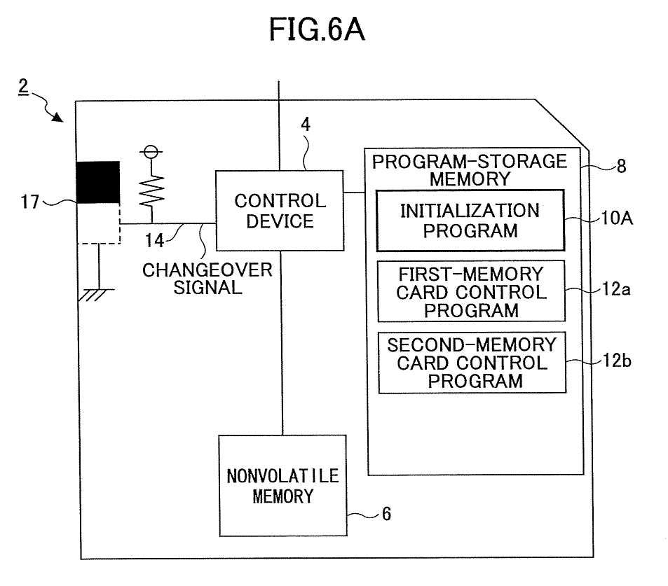

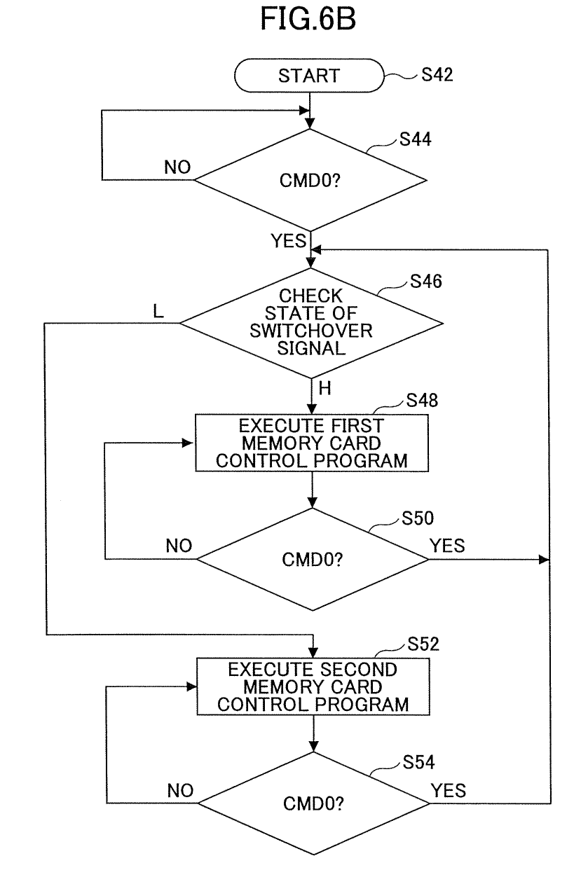

FIG. 6A is a block diagram showing an interior configuration of a nonvolatile memory card according to the sixth embodiment of the present invention. The nonvolatile memory card according to the sixth embodiment is substantially the same as the nonvolatile memory card according to the fifth embodiment. The same elements as those of such embodiment are referred to by the same numerals, and a description thereof will be omitted.

In the nonvolatile memory card 2 of the sixth embodiment, an initialization program 10A and control program have a program code embedded therein for analyzing a reset command sent from the host controller.

The switch 17 is set to an open position when the use of the nonvolatile memory card 2 as the first memory card is desired. In this case, the initialization program 10A or control program selects the control program for the first memory card upon the receipt by the control device 4 of a reset command sent from the host controller. As a result, the host controller can exchange data with the nonvolatile memory card 1 according to the method of the second memory card.

On the other hand, the switch 17 is set to a closed position when the use of the nonvolatile memory card 2 as the second memory card is desired. In this case, the initialization program 10A or control program selects the control program for the second memory card upon the receipt by the control device 4 of a reset command sent from the host controller. As a result, the host controller can exchange data with the nonvolatile memory card 2 according to the method of the second memory card.

FIG. 6B is a flowchart showing the operation of the control device that selects a control program for a memory card upon the receipt of a reset command sent from the host controller. Upon the receipt of a reset command by the initialization program 10A (“YES” at S44), the state of the changeover signal is checked (S46), and the control program for the first memory card (S48) or the control program for the second memory card (S52) is selected. The “H” state of the changeover signal indicates the selection of the first memory card, and the “L” state of the changeover signal indicates the selection of the second memory card.

Upon the receipt of a reset command by a control program (“YES” at S50, “YES” at S54), the state of the changeover signal is checked (S46) even during the execution of the control program, and the control program for the first memory card (S48) or the control program for the second memory card (S52) is newly selected.

In the following, a description will be given of an example of a memory card which is provided with a control program for the SD card and a control program for the MMC. The SD card corresponds to the first memory card described above, and the MMC corresponds to the second memory card described above. When an operation as the SD card is desired, the switch 17 is set to the open position. In this case, the initialization program 10A or control program selects the control program for the SD card upon the receipt of a reset command “CMD0” sent from the host controller. The host controller can exchange data with the nonvolatile memory card 2 according to the method of the SD card.

When an operation as the MMC is desired, the switch 17 is set to the closed position. In this case, the initialization program 10A or control program selects the control program for the MMC upon the receipt of a reset command “CMD0” sent from the host controller. The host controller can exchange data with the nonvolatile memory card 2 according to the method of the MMC.

Another example is that a memory card is provided with a control device for the SD card and a control device for the SDHC memory card. The SD card corresponds to the first memory card, and the SDHC memory card corresponds to the second memory card.

In the nonvolatile memory card 2 according to the sixth embodiment, the reset command used by the host controller to initialize the memory card is utilized to select a control program. Accordingly, no change in the setting of the control program occurs unless a reset command is generated. The selected standard of the memory card is not changed even when the switch is shifted to the other position for some reason.

### Seventh Embodiment

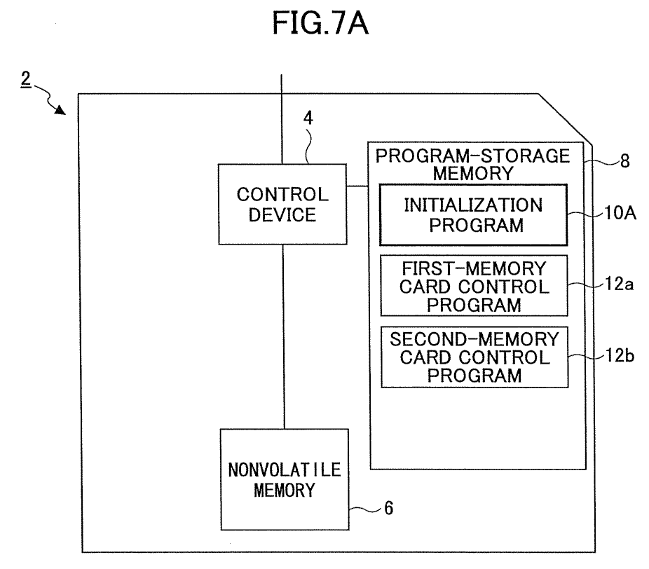

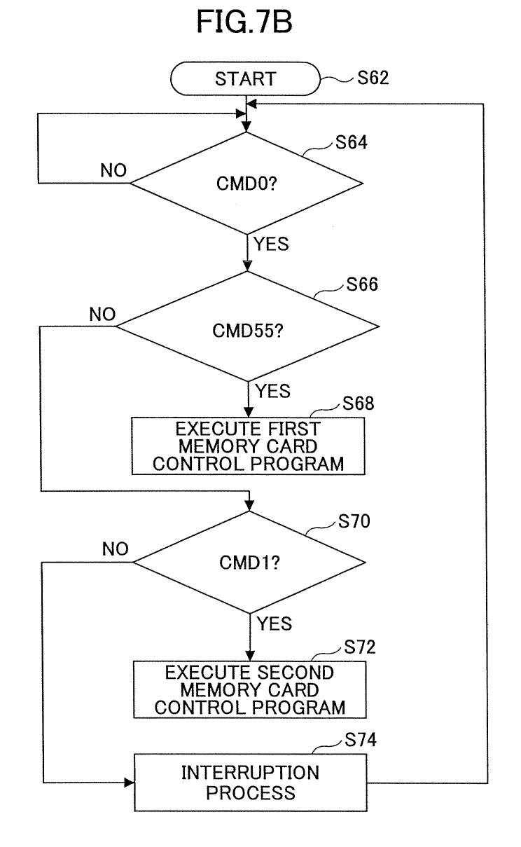

FIG. 7A is a block diagram showing an interior configuration of a nonvolatile memory card according to the seventh embodiment of the present invention. The nonvolatile memory card according to the seventh embodiment is substantially the same as the nonvolatile memory card according to the sixth embodiment. The same elements as those of such embodiment are referred to by the same numerals, and a description thereof will be omitted.

The nonvolatile memory card 2 according to the seventh embodiment is not provided with a switch. In the nonvolatile memory card 2 according to the seventh embodiment, the protocol of access by the host controller (not shown) is analyzed to select a control program.

In the nonvolatile memory card 2 of the seventh embodiment, an initialization program 10A and control program have a program code embedded therein for analyzing the protocol of access by the host controller for initializing the memory card.

When the initialization program 10A analyzes the protocol of access by the host controller and determines that the protocol is for the first memory card, the initialization program 10A selects the control program for the first memory card. The host controller can thus exchange data with the nonvolatile memory card 2 according to the method of the first memory card.

When the initialization program 10A analyzes the protocol of access by the host controller and determines that the protocol is for the second memory card, the initialization program 10A selects the control program for the second memory card. The host controller can thus exchange data with the nonvolatile memory card 2 according to the method of the second memory card. An interruption procedure is performed in response to the determination that the protocol is neither for the first memory card nor for the second memory card, thereby continuing the protocol analysis.

FIG. 7B is a flowchart showing the operation of the control device that selects a control program for a memory card by analyzing the protocol of access by the host controller. Upon the receipt of a reset command (e.g., “CMD0”) by the initialization program 10A (or control program) (“YES” at S64), a check is made as to whether the protocol is for the first memory card. If it is ascertained that the protocol is for the first memory card (“YES” at S66), the control program for the first memory card is selected and executed (S68). If it is ascertained that the protocol is for the second memory card (“NO” at S66, “YES” at S70), the control program for the second memory card is selected and executed (S72). An interruption process is performed (S74) in response to the determination that the protocol is neither for the first memory card nor for the second memory card (“NO” at S70), thereby awaiting for another reset command.

In the following, a description will be given of an example of a memory card which is provided with a control program for the SD card and a control program for the MMC. The SD card corresponds to the first memory card described above, and the MMC corresponds to the second memory card described above. Upon the consecutive receipt of CMD0 and CMD55 by the initialization program 10A (or control program), the initialization program 10A (or control program) selects the control program for the SD card. The host controller can exchange data with the nonvolatile memory card 2 according to the method of the SD card.

Upon the consecutive receipt of CMD0 and CMD1 by the initialization program 10A (or control program), the initialization program 10A (or control program) selects the control program for the MMC. The host controller can exchange data with the nonvolatile memory card 2 according to the method of the MMC.

Another example is that a memory card is provided with a control device for the SD card and a control device for the SDHC memory card. The SD card corresponds to the first memory card, and the SDHC memory card corresponds to the second memory card. It should be noted that in the case of these memory cards, the command at S70 of FIG. 7B is different (i.e., CMD8 should replace CMD1).

In the nonvolatile memory card 2 of the seventh embodiment, the initialization program 10A and control program analyze the protocol of access performed by the host controller to select a control program. This configuration thus requires no switch.

In the example used in the above-described embodiment, the number of control programs is two. Alternatively, more than two control programs for memory cards may be provided, and switching between these programs may be performed. Even in such a case, there is not need to provide additional switches unlike the first through sixth embodiment.

### Eighth Embodiment

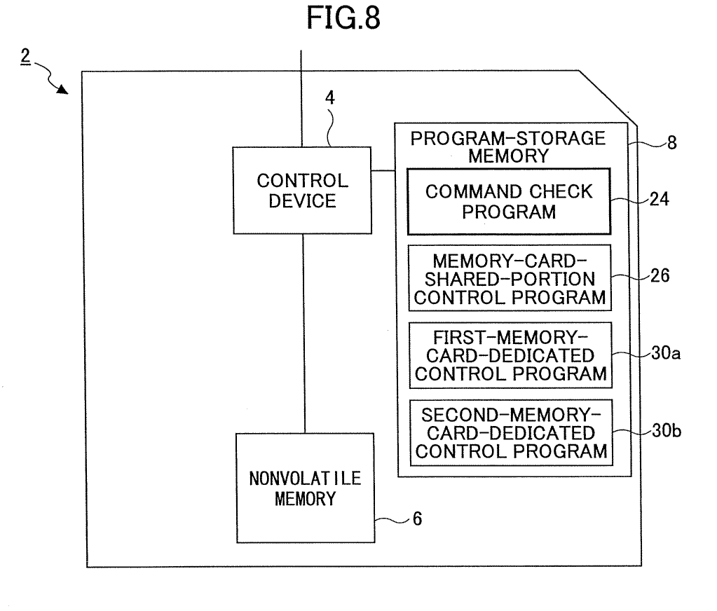

FIG. 8 is a block diagram showing an interior configuration of a nonvolatile memory card according to the eighth embodiment of the present invention. The nonvolatile memory card according to the eighth embodiment is substantially the same as the nonvolatile memory card according to the seventh embodiment. The same elements as those of such embodiment are referred to by the same numerals, and a description thereof will be omitted.

The nonvolatile memory card 2 according to the eighth embodiment is not provided with a switch. Further, no switching of control programs is performed. Despite such configuration, data transfer with host controllers having different specifications is made possible.

The nonvolatile memory card 2 of the eighth embodiment serves to perform data transfer between the nonvolatile memory 6 and a host controller (not shown) via the control device 4. The program-storage memory 8 stores therein a command check program 24, a memory-card-shared-portion control program 26, a first-memory-card-dedicated control program 30a, and a second-memory-card-dedicated control program 30b.

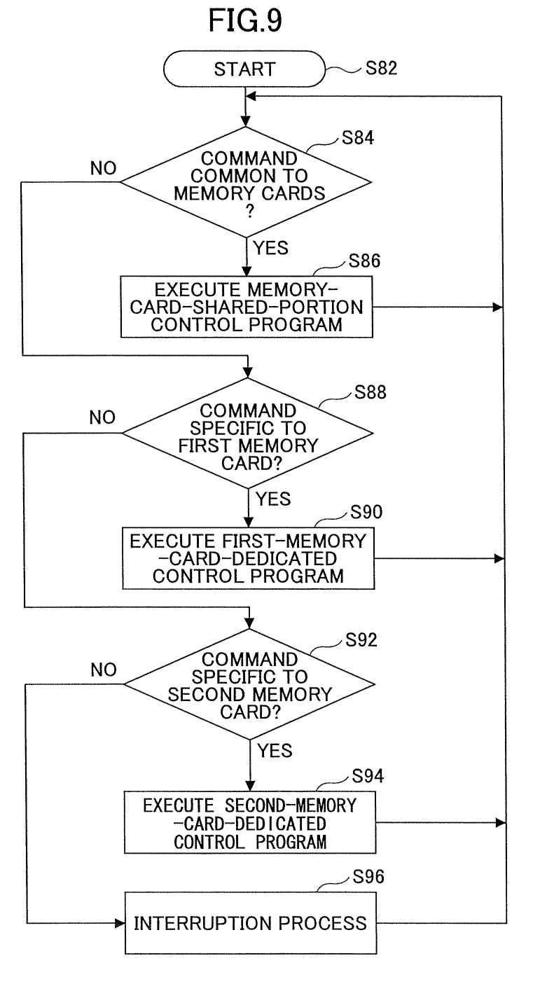

FIG. 9 is a flowchart showing the operation of the control device 4 of the memory card. Upon receiving a command from the host controller, the command check program 24 checks what the command is. If the command is of such a type that the command is used in common by all the memory cards (“YES” at S84), the command is passed to and processed by the memory-card-shared-portion control program 26 (S86). Then, the procedure returns to a check process performed by the command check program 24.

If the command is specific to the first memory cards (“NO” at S84, “YES” at S88), the command is passed to and processed by the first-memory-card-dedicated control program 30a (S90). Then, the procedure returns to a check process performed by the command check program 24.

If the command is specific to the second memory cards (“NO” at S84, “NO” at S88, “YES” at S92), the command is passed to and processed by the second-memory-card-dedicated control program 30b (S94). Then, the procedure returns to a check process performed by the command check program 24.

An interruption process is performed (S96) in response to the determination that the command is none of these types (“NO” at S84, “NO” at S88, “NO” at S92). Then, the procedure goes back to a check process by the command check program 24.

In the following, a description will be given of an example of a memory card which is provided with a command check program, an SD-card-&-MMC-shared-portion control program, an SD-card-dedicated control program, and an MMC-dedicated control program.

A description will be first given of the case in which the nonvolatile memory card 2 is inserted into an SD-card-dedicated slot (not shown) of a host computer (not shown). Upon receiving a command from the SD-card host controller, the command check program checks what the command is. If the command is of such a type that the command is used in common by all the memory cards, the command is passed to and processed by the memory-card-shared-portion control program. Then, the procedure returns to a check process performed by the command check program.

If the command is specific to the SD card, the command is passed to and processed by the SD-card-dedicated control program. Then, the procedure returns to a check process performed by the command check program. In this case, the SD-card host controller accesses the memory card of the present invention by treating it as an SD card since the memory card of the present invention properly responds to all the commands supported by the SD card. Further, since the host controller is designed for the SD card, the controller transmits no commands specific to the MMC. In no case, thus, is a command passed to the MMC-dedicated control program.

In the following, a description will be given of the case in which the nonvolatile memory card 2 is inserted into an MMC-dedicated slot (not shown) of a host computer (not shown). Upon receiving a command from the MMC host controller, the command check program checks what the command is. If the command is of such a type that the command is used in common by all the memory cards, the command is passed to and processed by the memory-card-shared-portion control program. Then, the procedure returns to a check process performed by the command check program.

If the command is specific to the MMC, the command is passed to and processed by the MMC-dedicated control program. Then, the procedure returns to a check process performed by the command check program. In this case, the MMC host controller accesses the memory card of the present invention by treating it as an MMC since the memory card of the present invention properly responds to all the commands supported by the MMC. Further, since the host controller is designed for the MMC, the controller transmits no commands specific to the SD card. In no case, thus, is a command passed to the SD-card-dedicated control program.

A description will further be given of the case in which the memory card is inserted into an SD-card-&MMC-compatible slot. In the case of a host controller that supports both the SD card and the MMC, the host controller needs to check whether the inserted memory card is an SD card or an MMC. The host controller determines what the memory card is by transmitting a command that is supported specifically by the SD card or supported specifically by the MMC and checking a response to the transmitted command.

For example, the host controller finds the MMC if a proper response is returned in response to the consecutive transmission of “CMD0” and “CMD1”, and finds the SD card if a proper response is returned in response to the consecutive transmission of “CMD0” and CMD55”.

The memory card of the present invention properly responds to a command when the host controller consecutively transmits “CMD0” and “CMD55” that are a command specific to the SD card. In this case, the host controller determines that the inserted memory card is an SD card, and thereafter accesses the memory card by use of commands that are supported by the SD card. Since the memory card of the present invention properly responds to the commands that are supported by the SD card, data transfer between the host controller and the memory card of the present invention will properly be performed.

By the same token, the memory card of the present invention properly operates as an MMC when the host controller makes a determination about the memory card by use of a command specific to the MMC.

Another example is a memory card which is provided with a command check program, an SD-card-&-SDHC-card-shared-portion control program, an SD-card-dedicated control program, and an SDHC-memory-card-dedicated control program. This memory card has substantially the same configuration and operation as the nonvolatile memory card 2 shown in FIG. 8 and FIG. 9.

In the nonvolatile memory card 2 according to the eighth embodiment, a control program can be shared, except for the control programs for processing commands specific to respective standards. The total size of the control programs can thus be reduced. Further, no switch is necessary since there is no need to switch control programs.

In the example used in the above-described embodiment, the number of control programs is two. Alternatively, more than two dedicated control programs for memory cards may be provided, and switching between these programs may be performed. Even in such a case, there is not need to provide additional switches unlike the first through sixth embodiment.

### [Embodiments of Nonvolatile Memory]

The nonvolatile memory card 2 according to the first through eighth embodiments described above is configured such that the control device 4 has various configurations. The nonvolatile memory card 2 according to ninth through fifteenth embodiments described in the following is configured such that the nonvolatile memory 6 has various configurations.

As was previously described, even if a controller compatible with the SD card is implemented in an SDHC memory card, the host controller designed to support the SD card cannot recognize the data area of the SDHC memory card exceeding 4 GB because the SD card does not support a data area exceeding 2 GB. The nonvolatile memory card according to the ninth through fifteenth embodiments is particularly directed to addressing this problem. Nonetheless to say, however, the present invention is not limited to these two particular types of cards.

In the ninth through fifteenth embodiments described below, the control device 4 is compatible with a plurality of memory cards. Namely, the control device 4 is at least provided with the function of a control device for a first memory card (i.e., a first-memory-card-compatible mode) and the function of a control device for a second memory card (i.e., a second-memory-card-compatible mode). For example, the control device 4 is provided with the function of an SD-card control device (i.e., an SD-card-compatible mode) and the function of an SDHC-memory-card control device (i.e., a SDHC-memory-card-compatible mode).

### Ninth Embodiment

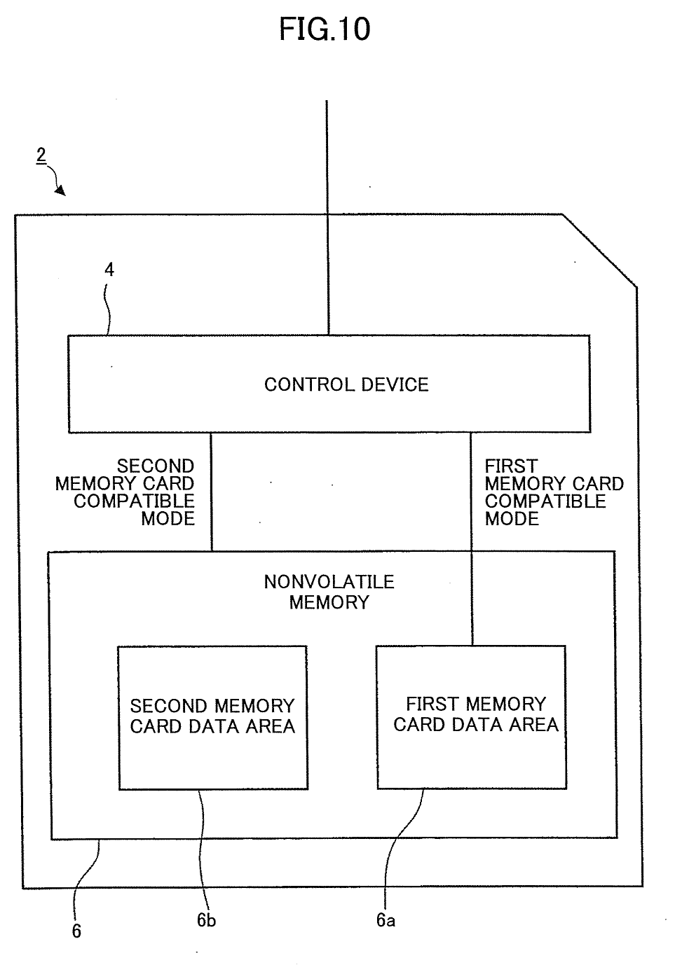

FIG. 10 is a block diagram showing an interior configuration of a nonvolatile memory card according to the ninth embodiment of the present invention. A nonvolatile memory card 2 according to the ninth embodiment includes a control device 4 and a nonvolatile memory 6, which is divided into a first memory card data area 6a and a second memory card data area 6b.

When the control device 4 operates in the first-memory-card-compatible mode, access to the first memory card data area is allowed. When the control device 4 operates in the second-memory-card-compatible mode, access to the second memory card data area is allowed.

When the control device 4 operates in the first-memory-card-compatible mode, no access to the second memory card data area is allowed. When the control device 4 operates in the second-memory-card-compatible mode, no access to the first memory card data area is allowed. No access can thus be made to a common data area of the memory card in the systems where respective host controllers support respective memory cards. Data cannot be shared between the systems via this memory card.

In the following, a description will be given of an example of a memory card which is provided with the function of a control device for the SD card and the function of a control device for the SDHC memory card. The SD card corresponds to the first memory card described above, and the SDHC memory card corresponds to the second memory card described above. The nonvolatile memory 6 of the memory card is divided into an SD-card data area and an SDHC-memory-card data area.

In this case, an SD-card host controller operates in the SD-card mode, and can access an SD-card data area smaller than 2 GB. An SDHC-memory-card host controller operates in the SDHC-memory-card mode, and can access the SDHC-memory-card data area.

However, the SDHC-memory-card host controller cannot access the SD-card data area when the control program automatically switches the functions of the control device 4 as in the case of the nonvolatile memory card 2 according to the seventh and eighth embodiments described above. Because of this, it is not possible to perform data exchange and data sharing between a system having an SD-card host controller and a system having an SDHC-memory-card host controller. If the nonvolatile memory card is configured as in the second through sixth embodiments described above such that the control device 4 or control program is manually switched, an SDHC-memory-card host controller can use an area corresponding to the 2 GB size to perform data exchange and data sharing by causing the control device 4 to operate in the SD-card-compatible mode.

### Tenth Embodiment

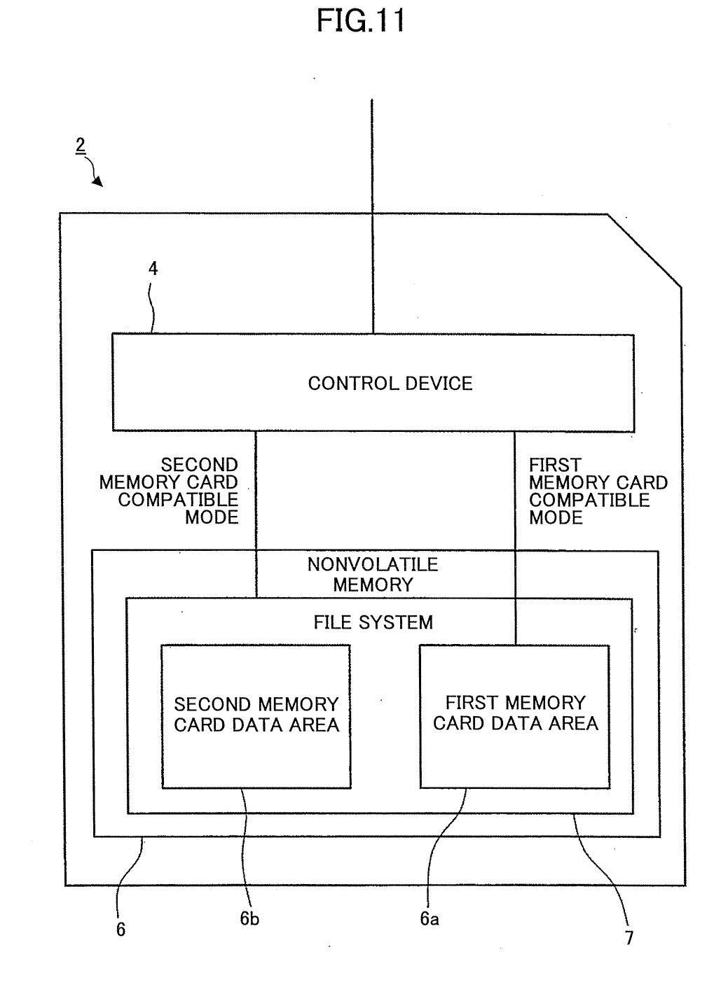

FIG. 11 is a block diagram showing an interior configuration of a nonvolatile memory card according to the tenth embodiment of the present invention. The nonvolatile memory card according to the tenth embodiment is substantially the same as the nonvolatile memory card according to the ninth embodiment. The same elements as those of such embodiment are referred to by the same numerals, and a description thereof will be omitted.

A nonvolatile memory card 2 according to the tenth embodiment has a single file system 7 in the nonvolatile memory 6, which is divided into a first memory card data area 6a and a second memory card data area 6b.

When the control device 4 operates in the first-memory-card-compatible mode, access to the first memory card data area is allowed. When the control device 4 operates in the second-memory-card-compatible mode, access to the second memory card data area is allowed.

When the control device 4 operates in the second-memory-card-compatible mode, accessing first-memory-card data in the file system 7 requires special software because the first memory card data area 6a exists as a single disk image file in the file system 7. Because of this, it is not possible for a system having a second-memory-card host controller to directly access the first memory card data area 6a. Namely, since no access can easily be made to a common data area of the memory card in the systems where respective host controllers support respective memory cards, it is not easy to share data between the systems via this memory card.

In the following, a description will be given of an example of a memory card which is provided with the function of a control device for the SD card and the function of a control device for the SDHC memory card. The SD card corresponds to the first memory card described above, and the SDHC memory card corresponds to the second memory card described above. The nonvolatile memory is divided into an SD-card data area and an SDHC-memory-card data area in the file system of the memory card.

In this case, an SD-card host controller operates in the SD-card mode, and can access an SD-card data area smaller than 2 GB that is in existence as a disk image file in the file system. An SDHC-memory-card host controller operates in the SDHC-memory-card mode, and can access the SDHC-memory-card data area.

In order to access data stored in the SD-card-compatible mode, the SDHC-memory-card host controller requires special software for accessing a disk image file in the SD-card data area when the control program automatically switches the functions of the control device 4 as in the case of the nonvolatile memory card 2 according to the seventh and eighth embodiments described above. Because of this, it is not easy to perform data exchange and data sharing between a system having an SD-card host controller and a system having an SDHC-memory-card host controller. If the nonvolatile memory card is configured as in the second through sixth embodiments described above such that the control device 4 or control program is manually switched, an SDHC-memory-card host controller can use an area corresponding to the 2 GB size to perform data exchange and data sharing by causing the control device 4 to operate in the SD-card-compatible mode.

### Eleventh Embodiment

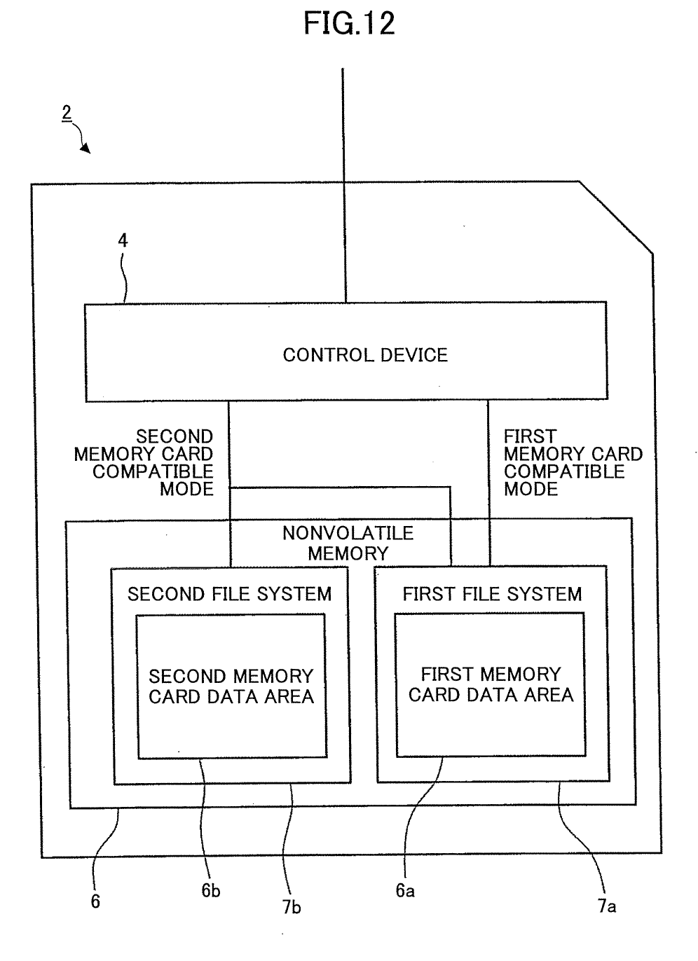

FIG. 12 is a block diagram showing an interior configuration of a nonvolatile memory card according to the eleventh embodiment of the present invention. The nonvolatile memory card according to the eleventh embodiment is substantially the same as the nonvolatile memory card according to the tenth embodiment. The same elements as those of such embodiment are referred to by the same numerals, and a description thereof will be omitted.

A nonvolatile memory card 2 according to the eleventh embodiment has a plurality of file systems (a first file system 7a and a second file system 7b) in the nonvolatile memory 6, and these file systems 7a and 7b are provided with a first memory card data area 6a and a second memory card data area 6b, respectively.

When the control device 4 operates in the first-memory-card-compatible mode, it is possible to access the first memory card data area 6a of the first file system 7a. When the control device 4 operates in the second-memory-card-compatible mode, the control device 4 can access the first memory card data area 6a of the first file system 7a and the second memory card data area 6b of the second file system 7b if provision is made such that the respective file systems 7a and 7b can independently be recognized.

In this case, a system having a first-memory-card host controller can access a single file system (i.e., the first file system 7a) in the first-memory-card-compatible mode. Further, a system having a second-memory-card host controller can access a plurality of file systems (i.e., the first file system 7a and the second file system 7b) in the second-memory-card-compatible mode.

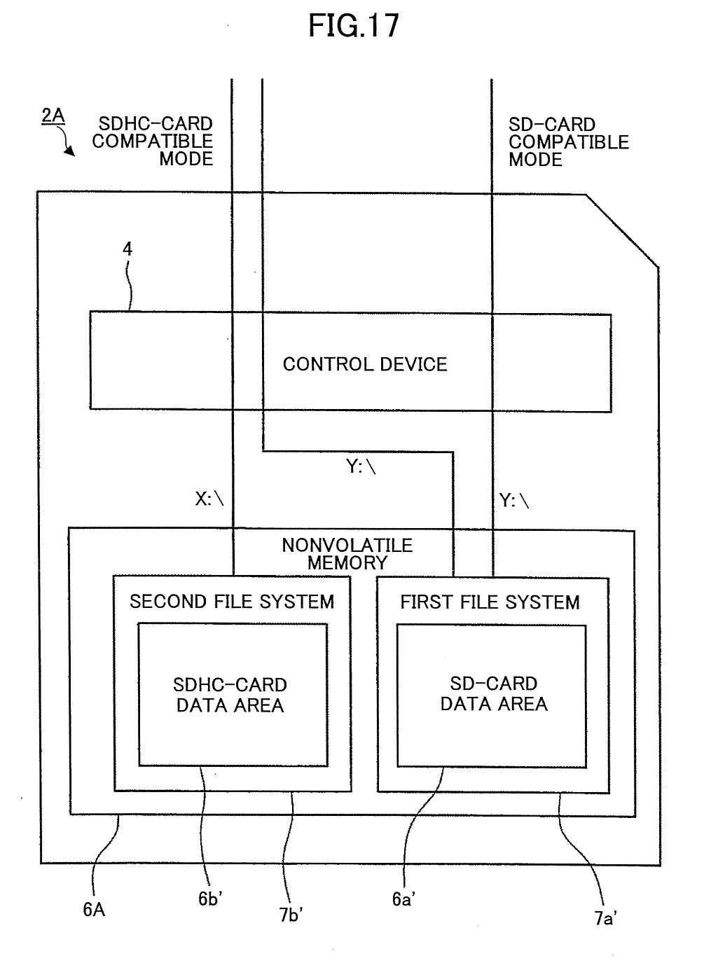

An example will be considered here of a memory card which is provided with the function of a control device for the SD card and the function of a control device for the SDHC memory card as shown in FIG. 17. In a nonvolatile memory 6A of the nonvolatile memory card 2A shown in FIG. 17, a first file system 7a′ is provided with an SD-card data area 6a′, and a second file system 7b′ is provided with a SDHC-memory-card data area 6b′.

In this case, a system having an SD-card host controller operates in the SD-card mode, and can access an SD-card data area 6a′ smaller than 2 GB that is provided in the first file system 7a′ and detected as being a certain drive (e.g., “Y drive”).

Further, a system having an SDHC-memory-card host controller operates in the SDHC-memory-card mode, and can access an SDHC-memory-card data area 6b′ that is provided in the second file system 7b′ and detected as being another drive (e.g., “X drive”). Moreover, an SD-card data area 6a′ smaller than 2 GB that is provided in the first file system 7a′ is detected as a “Y drive”, and is accessible. Namely, the SD-card data area 6a′ and the SDHC-memory-card data area 6b′ are detected as two respective drives.

Because of this, it is possible to easily perform data exchange between a system having an SD-card host controller and a system having an SDHC-memory-card host controller, thereby providing the shared use of data via a single memory card.

In the nonvolatile memory card 2 according to the eleventh embodiment, a file system is divided into pieces. Provision may be made such that an SD-card data area is provided in the single file system (such as that of the tenth embodiment) and such that this data area is detected as a different drive than the drive for the SDHC-memory-card data area. With this provision, the same function and result are obtained as those of the nonvolatile memory card 2 of the eleventh embodiment.

### Twelfth Embodiment

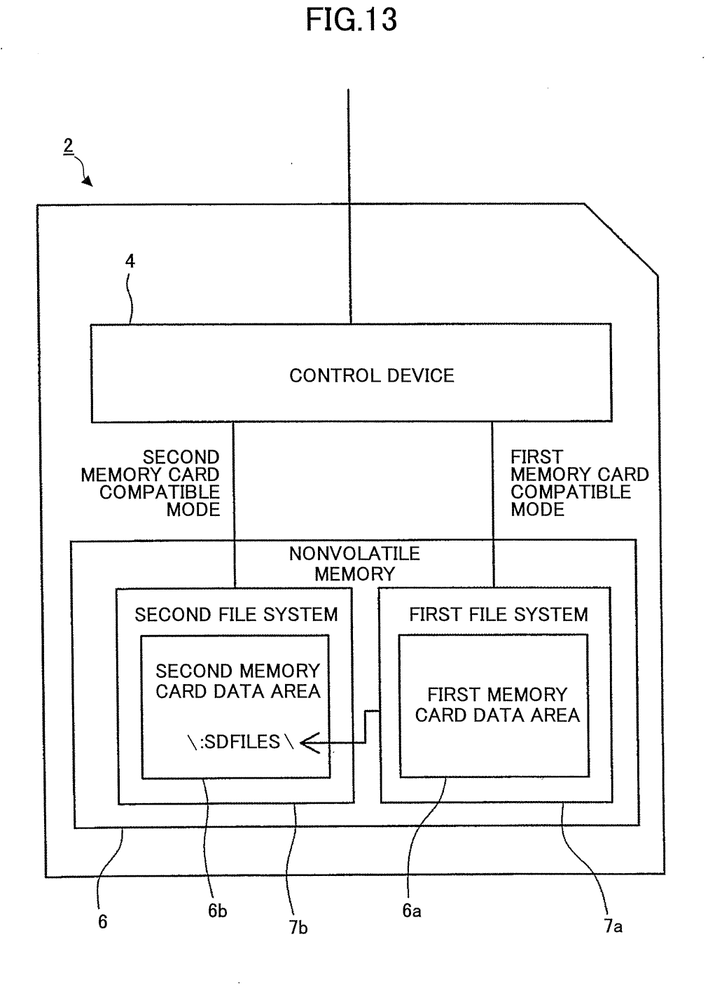

FIG. 13 is a block diagram showing an interior configuration of a nonvolatile memory card according to the twelfth embodiment of the present invention. The nonvolatile memory card according to the twelfth embodiment is substantially the same as the nonvolatile memory card according to the eleventh embodiment. The same elements as those of such embodiment are referred to by the same numerals, and a description thereof will be omitted.

A nonvolatile memory card 2 according to the eleventh embodiment has a nonvolatile memory 6 thereof divided into a plurality of partitions. These partitions are provided with respective file systems (a first file system 7a and a second file system 7b), and these file systems 7a and 7b are provided with a first memory card data area 6a and a second memory card data area 6b, respectively.

When the control device 4 operates in the first-memory-card-compatible mode, it is possible to access the first memory card data area 6a of the first file system 7a. When the control device 4 operates in the second-memory-card-compatible mode, it is possible to access the second memory card data area of the second file system. Further, the first memory card data area 6a of the first file system 7a is allocated to a specific directory in the second file system 7b, which makes it possible to access the first memory card data area 6a indirectly through the second file system 7b.

In this case, a system having a first-memory-card host controller can access a single file system (i.e., the first file system 7a) in the first-memory-card-compatible mode. Further, a system having a second-memory-card host controller can access both memory card data areas via a single file system (i.e., the second file system 7b) in the second-memory-card-compatible mode.

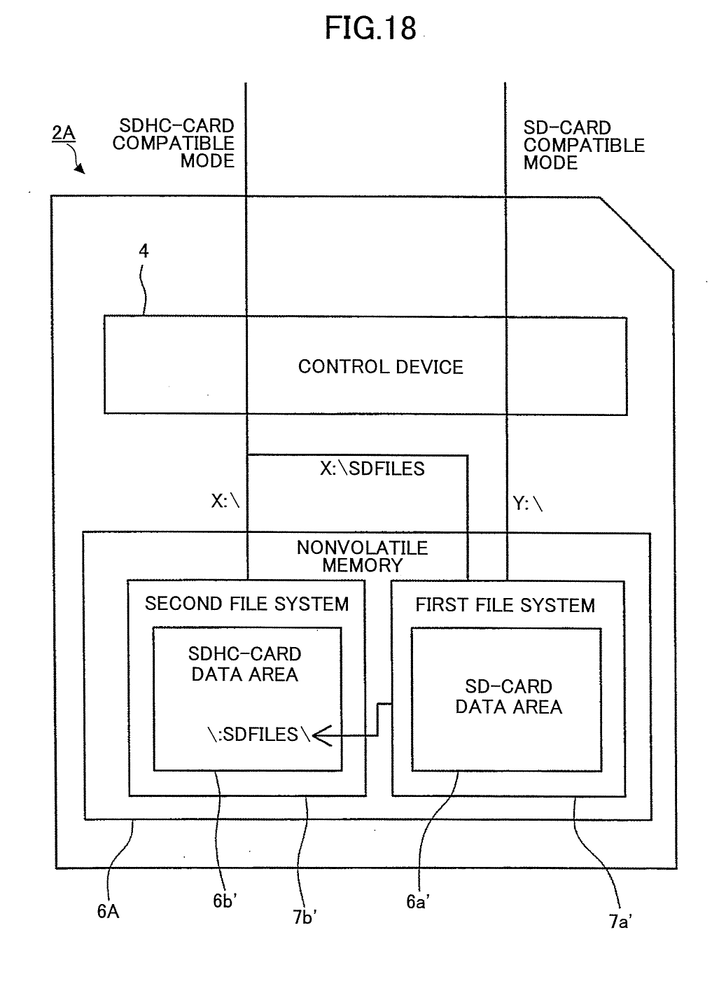

An example will be considered here of a memory card which is provided with the function of a control device for the SD card and the function of a control device for the SDHC memory card as shown in FIG. 18. A nonvolatile memory 6A of a nonvolatile memory card 2A shown in FIG. 18 is divided into a plurality of partitions, which include respective file systems (i.e., the first file system 7a′ and the second file system 7b′). The first file system 7a′ is provided with an SD-card data area 6a′, and the second file system 7b′ is provided with a SDHC-memory-card data area 6b′.

In this case, a system having an SD-card host controller operates in the SD-card mode, and can access an SD-card data area 6a′ smaller than 2 GB that is provided in the first file system 7a′ and detected as being a certain drive (e.g., “Y drive”).

Further, a system having an SDHC-memory-card host controller operates in the SDHC-memory-card mode, and can access an SDHC-memory-card data area 6b′ that is provided in the second file system 7b′ and detected as being another drive (e.g., “X drive”). The SD-card data area 6a′ smaller than 2 GB is allocated to a directory SDFILES in the second file system 7b′ that is provided with the SDHC-memory-card data area 6b′. With this provision, the system having the SDHC-memory-card host controller can access the SD-card data area 6a′.

Namely, accessing the second file system 7b′ makes it possible to access the first file system having the SD-card data area. Because of this, it is possible to easily perform data exchange between a system having an SD-card host controller and a system having an SDHC-memory-card host controller, thereby providing the shared use of data via a single memory card.

In the nonvolatile memory card 2 according to the twelfth embodiment, a file system is divided into pieces. Provision may be made such that an SD-card data area is provided in the single file system (such as that of the tenth embodiment) and such that this data area is recognized as a directory in the second file system. With this provision, the same function and result are obtained as those of the nonvolatile memory card 2 of the twelfth embodiment.

### Thirteenth Embodiment

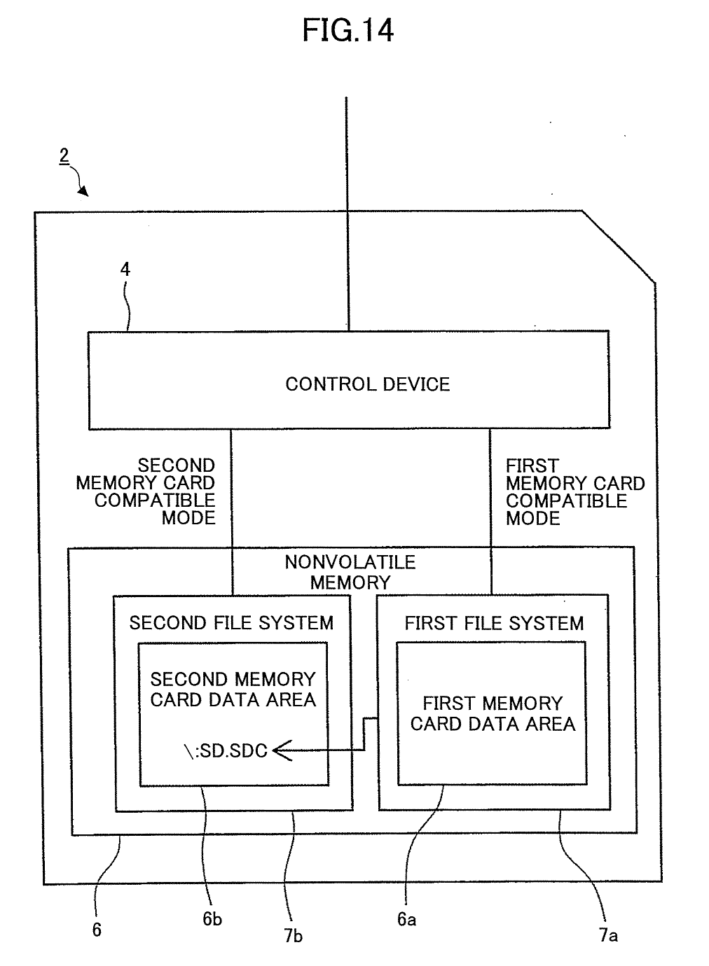

FIG. 14 is a block diagram showing an interior configuration of a nonvolatile memory card according to the thirteenth embodiment of the present invention. The nonvolatile memory card according to the thirteenth embodiment is substantially the same as the nonvolatile memory card according to the twelfth embodiment. The same elements as those of such embodiment are referred to by the same numerals, and a description thereof will be omitted.

A nonvolatile memory card 2 according to the thirteenth embodiment has a nonvolatile memory 6 thereof divided into a plurality of partitions. These partitions are provided with respective file systems (a first file system 7a and a second file system 7b), and these file systems 7a and 7b are provided with a first memory card data area 6a and a second memory card data area 6b, respectively.

When the control device 4 operates in the first-memory-card-compatible mode, it is possible to access the first memory card data area 6a of the first file system 7a. When the control device 4 operates in the second-memory-card-compatible mode, it is possible to access the second memory card data area of the second file system. Further, the first memory card data area 6a of the first file system 7a is allocated to a specific file in the second file system 7b, which makes it possible to access the first memory card data area 6a indirectly through the second file system 7b.

Operating in the second-memory-card-compatible mode, the first memory card data area 6a exists as a single disk image file in the second file system, for example. Because of this, special software for accessing the first memory card data (area) of this image file is necessary, thereby making it impossible for a system having a second-memory-card host controller to achieve a direct access. Namely, since no access can easily be made to a common data area of the nonvolatile memory by the systems having respective host controllers, it is not easy to share data between the systems via this memory card.

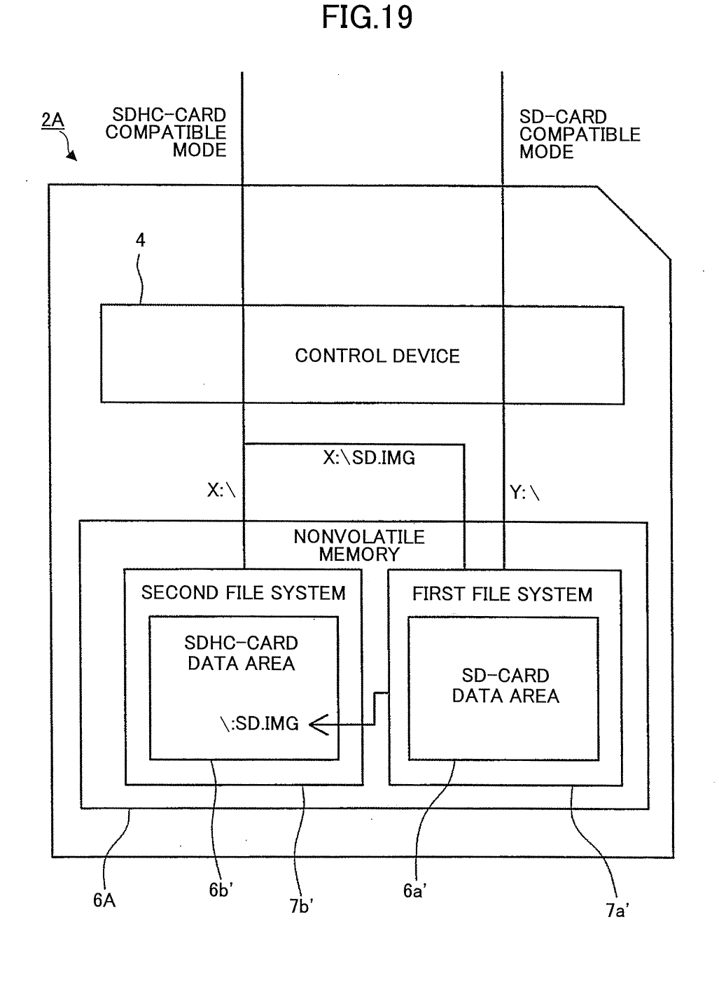

An example will be considered here of a memory card which is provided with the function of a control device for the SD card and the function of a control device for the SDHC memory card as shown in FIG. 19. A nonvolatile memory 6A of a nonvolatile memory card 2A shown in FIG. 19 is divided into a plurality of partitions, which include respective file systems (i.e., the first file system 7a′ and the second file system 7b′). The first file system 7a′ is provided with an SD-card data area 6a′, and the second file system 7b′ is provided with a SDHC-memory-card data area 6b′.

In this case, a system having an SD-card host controller operates in the SD-card mode, and can access an SD-card data area 6a′ smaller than 2 GB that is provided in the first file system 7a′ and detected as being a certain drive (e.g., “Y drive”).

Further, a system having an SDHC-memory-card host controller operates in the SDHC-memory-card mode, and can access an SDHC-memory-card data area 6b′ that is provided in the second file system 7b′ and detected as being another drive (e.g., “X drive”). The SD-card data area 6a′ smaller than 2 GB is allocated to a file “SD.IMG” in the second file system 7b′ that is provided with the SDHC-memory-card data area 6b′. With this provision, the system having the SDHC-memory-card host controller can access the SD-card data area 6a′.

It should be noted, however, that since the file “SD.IMG” exists as a disk image file, accessing the SD-card data (area) of this image file requires special software. Namely, the system having the SDHC-memory-card host controller cannot directly access the SD-card data (area). In other words, since no access can easily be made to a common data area of the nonvolatile memory by the systems having respective host controllers, it is not easy to share data between the systems via this memory card.

If the nonvolatile memory card is configured as in the second through sixth embodiments described above such that the control device 4 or control program is manually switched, an SDHC-memory-card host controller can use an area corresponding to the 2 GB size to perform data exchange and data sharing by causing the control device 4 to operate in the SD-card-compatible mode.

### Fourteenth Embodiment

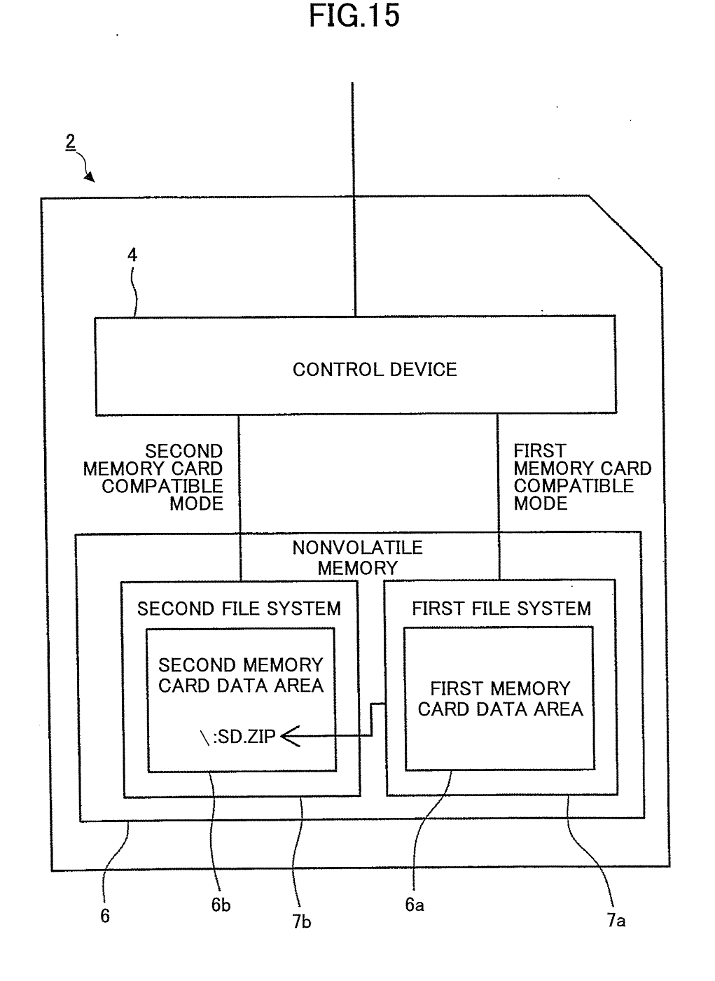

FIG. 15 is a block diagram showing an interior configuration of a nonvolatile memory card according to the fourteenth embodiment of the present invention. The nonvolatile memory card according to the fourteenth embodiment is substantially the same as the nonvolatile memory card according to the thirteenth embodiment. The same elements as those of such embodiment are referred to by the same numerals, and a description thereof will be omitted.

A nonvolatile memory card 2 according to the fourteenth embodiment has a nonvolatile memory 6 thereof divided into a plurality of partitions. These partitions are provided with respective file systems (a first file system 7a and a second file system 7b), and these file systems 7a and 7b are provided with a first memory card data area 6a and a second memory card data area 6b, respectively.

When the control device 4 operates in the first-memory-card-compatible mode, it is possible to access the first memory card data area 6a of the first file system 7a. When the control device 4 operates in the second-memory-card-compatible mode, it is possible to access the second memory card data area of the second file system. Further, the first memory card data area 6a of the first file system 7a is allocated as a specific general-purpose compressed file in the second file system 7b, which makes it possible to access the first memory card data area 6a indirectly through the second file system 7b.

In this case, when the second-memory-card-compatible mode is used, the first memory card data area 6a exists as a compressed file in the second file system. Because of this, software for manipulating a compressed file is necessary to access the first memory card data (area) of this compressed file, thereby making it impossible for a system having a second-memory-card host controller to achieve a direct access.

Since the file is a general-purpose compressed file, however, there is no need to define the format of the file. In contrast to the tenth embodiment and the thirteenth embodiment, it is relatively easy for the systems having respective host controllers to access a common data area of the nonvolatile memory, thereby making it easier to share data between the systems via this memory card.

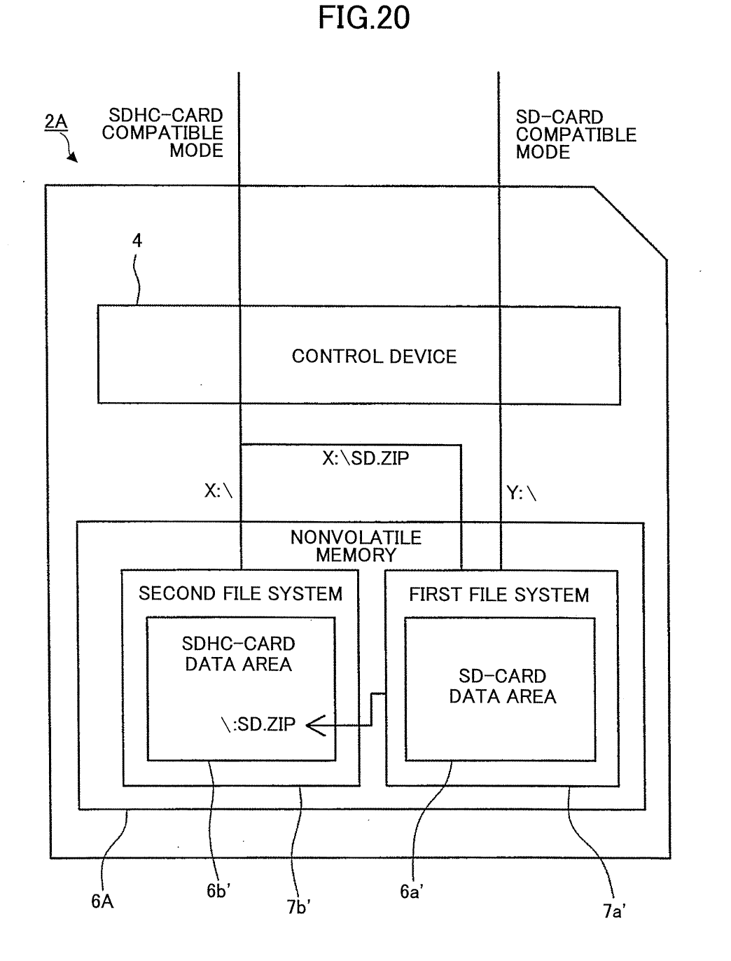

An example will be considered here of a memory card which is provided with the function of a control device for the SD card and the function of a control device for the SDHC memory card as shown in FIG. 20. A nonvolatile memory 6A of a nonvolatile memory card 2A shown in FIG. 20 is divided into a plurality of partitions, which include respective file systems (i.e., the first file system 7a′ and the second file system 7b′). The first file system 7a′ is provided with an SD-card data area 6a′, and the second file system 7b′ is provided with a SDHC-memory-card data area 6b′.

In this case, a system having an SD-card host controller operates in the SD-card mode, and can access an SD-card data area 6a′ smaller than 2 GB that is provided in the first file system 7a′ and detected as being a certain drive (e.g., “Y drive”).

Further, a system having an SDHC-memory-card host controller operates in the SDHC-memory-card mode, and can access an SDHC-memory-card data area 6b′ that is provided in the second file system 7b′ and detected as being another drive (e.g., “X drive”). The SD-card data area 6a′ smaller than 2 GB is allocated to a file “SD.ZIP” in the second file system 7b′ that is provided with the SDHC-memory-card data area 6b′. With this provision, the system having the SDHC-memory-card host controller can access the SD-card data area 6a′.

Since the file “SD.ZIP” exists as a compressed file, accessing the SD-card data (area) of this compressed file requires special software for manipulating the compressed file. Namely, the system having the SDHC-memory-card host controller cannot directly access the SD-card data (area).

Since the ZIP file is a general-purpose compressed file, however, there is no need to define the format of the file. In contrast to the tenth embodiment and the thirteenth embodiment, it is relatively easy for the systems having respective host controllers to access a common data area of the nonvolatile memory, thereby making it relatively easier to share data between the systems via this memory card.

In the nonvolatile memory card 2 according to the fourteenth embodiment, a file system is divided into pieces. Provision may be made such that an SD-card data area is provided in the single file system (such as that of the tenth embodiment) and such that this data area is recognized as a compressed file such as AIP in the second file system. With this provision, the same function and result are obtained as those of the nonvolatile memory card 2 of the fourteenth embodiment.

### Fifteenth Embodiment

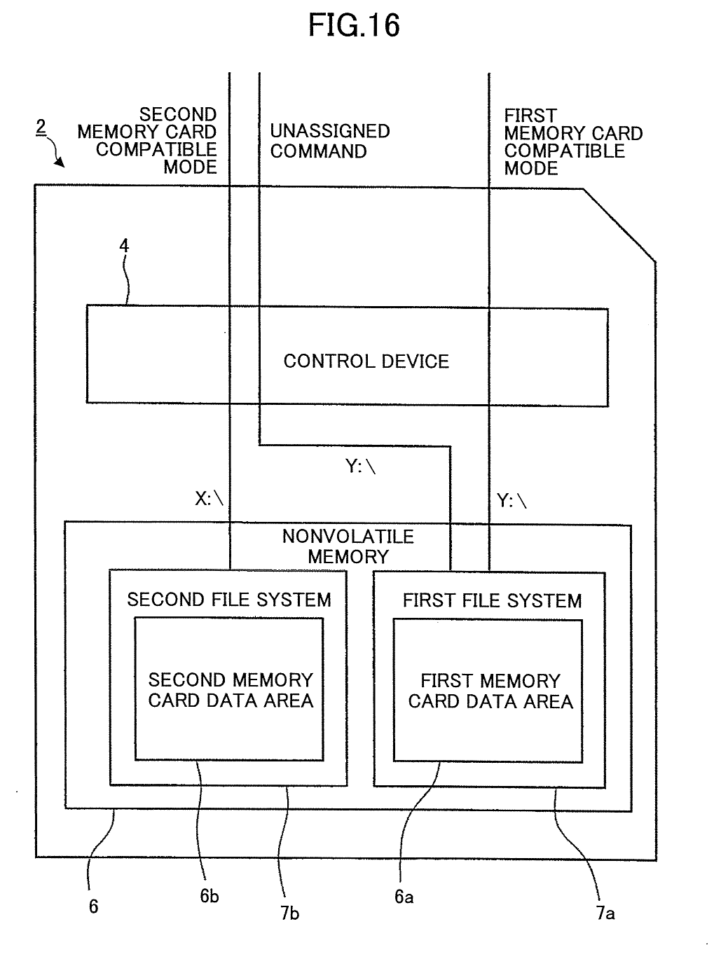

FIG. 16 is a block diagram showing an interior configuration of a nonvolatile memory card according to the fifteenth embodiment of the present invention. The nonvolatile memory card according to the fifteenth embodiment is substantially the same as the nonvolatile memory card according to the fourteenth embodiment. The same elements as those of such embodiment are referred to by the same numerals, and a description thereof will be omitted.

A nonvolatile memory card 2 according to the fourteenth embodiment has a plurality of file systems (a first file system 7a and a second file system 7b) in the nonvolatile memory 6, and these file systems 7a and 7b are provided with a first memory card data area 6a and a second memory card data area 6b, respectively.

When the control device 4 operates in the first-memory-card-compatible mode, it is possible to access the first memory card data area 6a of the first file system 7a. When the control device 4 operates in the second-memory-card-compatible mode, it is possible to access the second memory card data area of the second file system. Provision is further made such that when the control device 4 operates in the second-memory-card-compatible mode, it is possible to access the first memory card data area 6a of the first file system 7a by use of a command that is used by neither the first memory card nor the second memory card.

In this case, a system having a first-memory-card host controller can access a single file system (i.e., the first file system 7a) in the first-memory-card-compatible mode. A system having a second-memory-card host controller can access a plurality of file systems in the second-memory-card-compatible mode. When a command supported by neither the first memory card nor the second memory card is utilized, however, compatibility with these two memory cards cannot be maintained any longer.

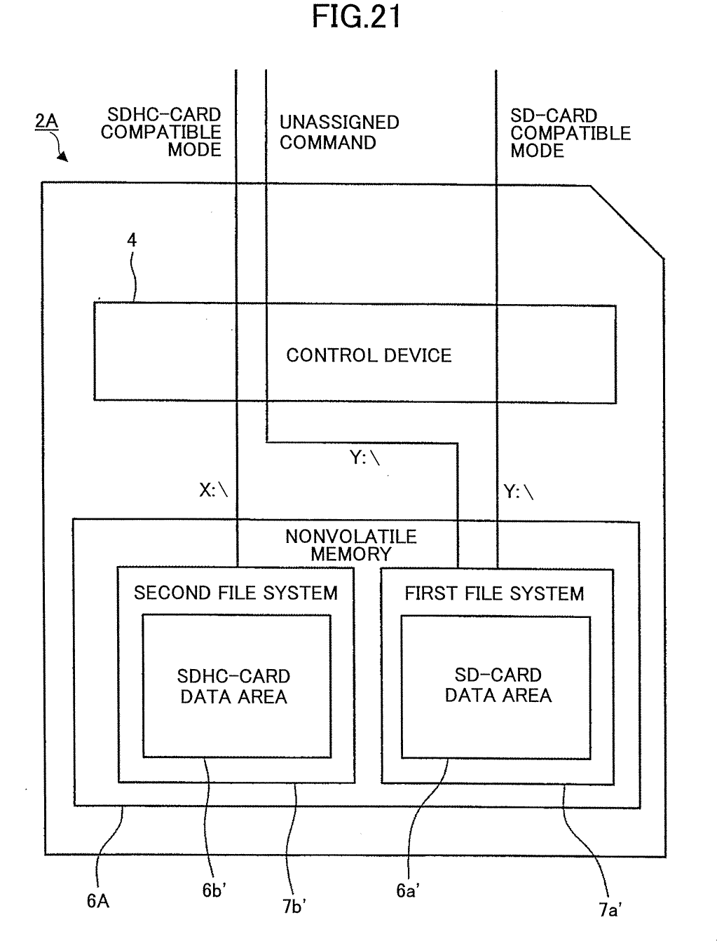

An example will be considered here of a memory card which is provided with the function of a control device for the SD card and the function of a control device for the SDHC memory card as shown in FIG. 21. A nonvolatile memory 6A of a nonvolatile memory card 2A shown in FIG. 21 includes a plurality of file systems (i.e., the first file system 7a′ and the second file system 7b′). The first file system 7a′ is provided with an SD-card data area 6a′, and the second file system 7b′ is provided with a SDHC-memory-card data area 6b′.

In this case, a system having an SD-card host controller operates in the SD-card mode, and can access an SD-card data area 6a′ smaller than 2 GB that is provided in the first file system 7a′ and detected as being a certain drive (e.g., “Y drive”).

Further, a system having an SDHC-memory-card host controller operates in the SDHC-memory-card mode, and can access an SDHC-memory-card data area 6b′ that is provided in the second file system 7b′ and detected as being another drive (e.g., “X drive”). Moreover, when a command used by neither the SD card nor the SDHC memory card is used to access the SDHC memory card, an SD-card data area 6a′ smaller than 2 GB that is provided in the first file system 7a′ is detected as a “Y drive” and accessed. Namely, the SD-card data area and the SDHC-memory-card data area are detected (recognized) as two respective drives.

Because of this, it is easy to perform data exchange between a system having an SD-card host controller and a system having an SDHC-memory-card host controller, thereby providing the shared use of data via a single memory card. It should be noted, however, that since a command supported by neither the SD card nor the SDHC memory card is used, there is a need to use a control program not complying with the SDHC memory card in the SDHC host controller.

In the nonvolatile memory card 2 according to the fifteenth embodiment, a file system is divided into pieces. Provision may be made such that an SD-card data area is provided in the single file system (such as that of the tenth embodiment) and such that this data area is detected (recognized) as a different drive than the drive for the second file system 7b in response to a command supported by neither the SD card nor the SDHC memory card. With this provision, the same function and result are obtained as those of the nonvolatile memory card 2 of the fifteenth embodiment.

Further, a directory or file may be allocated in place of a drive as in the twelfth, thirteenth, or fourteenth embodiment.

Although the present invention has been described with reference to embodiments, the present invention is not limited to these embodiments, but various variations and modifications may be made without departing from the scope of the invention as set forth in the accompanying claims.

The present application is based on Japanese priority application No. 2006-240294 filed on Sep. 5, 2006, with the Japanese Patent Office, the entire contents of which are hereby incorporated by reference.

1. A memory card, comprising:
a control device;
a nonvolatile memory; and
a program-storage memory,
wherein the program-storage memory is arranged to store a plurality of control programs corresponding to respective standards for controlling data access between the nonvolatile memory and an external device.

2. A memory card, comprising:
a plurality of control devices;
a nonvolatile memory; and
a write-protection switch,
wherein the control devices are configured to control data access between the nonvolatile memory and an external device according to respective memory card standards, and the write-protection switch is configured as a changeover switch to select one of the control devices.

3. A memory card, comprising:
a control device;
a nonvolatile memory;
a program-storage memory; and
a write-protection switch,
wherein the program-storage memory is arranged to store a plurality of control programs corresponding to respective standards for controlling data access between the nonvolatile memory and an external device, and the write-protection switch is configured as a changeover switch to select one of the control programs.

4. The memory card as claimed in claim 1, further comprising:
a switch,
wherein the control device is configured to monitor a state of a signal supplied from the switch to execute one of the control programs for a selected memory card in response to the state of the signal.

5-6. (canceled)

7. The memory card as claimed in claim 1, further comprising:
a switch; and
a reset signal acquisition circuit,
wherein the control device is configured to respond to the reset signal acquisition circuit acquiring a reset signal by receiving a state of a signal supplied from the switch to execute one of the control programs for a selected memory card in response to the state of the signal.

8-9. (canceled)

10. The memory card as claimed in claim 1, further comprising:
a switch,
wherein the control device is configured to respond to a predetermined command supplied from an external device by receiving a state of a signal supplied from the switch to execute one of the control programs for a selected memory card in response to the state of the signal.

11-12. (canceled)

13. The memory card as claimed in claim 1,
wherein the control device is configured to monitor a command supplied from or protocol of access made by an external device, to select one of the control programs in response to the monitored command or protocol, and to execute the selected one of the control programs for a selected memory card.

14-15. (canceled)

16. The memory card as claimed in claim 1,
wherein the program-storage memory is arranged to store a command check program for checking a command supplied from an external device and a memory-card-shared-portion control program in addition to the plurality of control programs corresponding to the respective standards,
wherein the memory-card-shared-portion control program is configured to control data access between the nonvolatile memory and the external device by performing control that is common to a plurality of memory cards corresponding to the respective standards,
wherein the control programs are configured to control the data access between the nonvolatile memory and the external device by performing control specific to the respective memory cards,
and wherein the control device is configured to use the command check program to check a command supplied from an external device, and to select and execute at least one of the memory-card-shared-portion control program and the control programs in response to the checked command.

17. The memory card as claimed in claim 1,
wherein the respective standards include an SD-card standard and an MMC standard.

18. The memory card as claimed in claim 2, wherein
the plurality of control devices include an SD-card control device and an MMC control device, and
wherein the SD-card control device and the MMC control device are configured to control data access between the nonvolatile memory and the external device according to an SD-card standard and an MMC standard respectively, and the write-protection switch is configured as a changeover switch to select one of the SD-card control device and the MMC control device.

19. The memory card as claimed in claim 3,
wherein the respective standards include an SD-card standard and an MMC standard.

20. The memory card as claimed in claim 4,
wherein the respective standards include an SD-card standard and an MMC standard.

21-22. (canceled)

23. The memory card as claimed in claim 7,
wherein the respective standards include an SD-card standard and an MMC standard.

24-25. (canceled)

26. The memory card as claimed in claim 10,
wherein the respective standards include an SD-card standard and an MMC standard.

27-28. (canceled)

29. The memory card as claimed in claim 13,
wherein the respective standards include an SD-card standard and an MMC standard.

30-31. (canceled)

32. The memory card as claimed in claim 16,
wherein the control programs include an SD-card-dedicated control program and an MMC-dedicated control program,
wherein the memory-card-shared-portion control program is configured to control data access between the nonvolatile memory and an external device by performing control that is common to an SD card and an MMC,
wherein the SD-card-dedicated control program is configured to control the data access between the nonvolatile memory and the external device by performing control specific to the SD card,
wherein the MMC-dedicated control program is configured to control the data access between the nonvolatile memory and the external device by performing control specific to the MMC,
and wherein the control device is configured to use the command check program to check a command supplied from an external device, and to select and execute at least one of the memory-card-shared-portion control program, the SD-card-dedicated control program, and MMC-dedicated control program in response to the checked command.

33-63. (canceled)
